(19) United States
(12) Patent Application Publication
(10) Pub. No.: US 2024/0071394 A1
(43) Pub. Date: Feb. 29, 2024

(54) Enhanced Orientation Signalling for Immersive Communications

(71) Applicant: Nokia Technologies Oy, Espoo (FI)

(72) Inventor: Lasse LAAKSONEN, Tampere (FI)

(21) Appl. No.: 17/766,462

(22) PCT Filed: Sep. 29, 2020
(86) PCT No.: PCT/FI2020/050638

§ 371 Date: Apr. 4, 2022

(30) Foreign Application Priority Data
Oct. 10, 2019 (GB) 1914665.3

(51) Int. Cl. G10L 19/008

(52) U.S. Cl. CPC G10L 19/008; H04S 7/304

(57) ABSTRACT

An apparatus including circuitry configured to: obtain at least one audio scene including at least one audio signal; obtain orientation information associated with the apparatus, wherein the orientation information includes information associated with a default scene orientation and orientation of the apparatus; encode the at least one audio signal; encode the orientation information; and output or store the encoded at least one audio signal and encoded orientation information.

### FIELD

The present application relates to apparatus and methods for converting enhanced orientation signalling for immersive communications, but not exclusively for enhanced orientation signalling for immersive communications within a spatial audio signal environment.

### BACKGROUND

Immersive audio codecs are being implemented supporting a multitude of operating points ranging from a low bit rate operation to transparency. An example of such a codec is the Immersive Voice and Audio Services (IVAS) codec which is being designed to be suitable for use over a communications network such as a 3GPP 4G/5G network including use in such immersive services as for example immersive voice and audio for virtual reality (VR). This audio codec is expected to handle the encoding, decoding and rendering of speech, music and generic audio. It is furthermore expected to support channel-based audio and scene-based audio inputs including spatial information about the sound field and sound sources. The codec is also expected to operate with low latency to enable conversational services as well as support high error robustness under various transmission conditions.

### SUMMARY

There is provided according to a first aspect an apparatus comprising means configured to: obtain at least one audio scene comprising at least one audio signal; obtain orientation information associated with the apparatus, wherein the orientation information comprises information associated with a default scene orientation and orientation of the apparatus; encode the at least one audio signal; encode the orientation information; and output or store the encoded at least one audio signal and encoded orientation information.

The orientation information may further comprise at least one of: orientation of a user operating the apparatus; information indicating whether orientation compensation is being applied to the at least one audio signal by the apparatus; an orientation reference; and orientation information identifying a global orientation reference.

The means configured to obtain orientation information associated with the apparatus may be configured to obtain orientation information associated with the apparatus for at least one of: once as part of an initialization procedure; on a regular basis determined by a time period; based on a user input requesting the orientation information; and based on a determined operation mode change of the apparatus.

The means configured to encode the orientation information may be configured to perform at least one of: encode the orientation information based on a determination of a format of the encoded at least one audio signal; and encode the orientation information based on a determination of an available bit rate for the encoded orientation information.

The means configured to encode the orientation information may be configured to: compare the information associated with a default scene orientation and orientation of the apparatus; encode both of the information associated with a default scene orientation and the orientation of the apparatus based on the comparison of the information associated with a default scene orientation and orientation of the apparatus differing by more than a threshold value; and encode only the information associated with a default scene orientation based on the comparison of the information associated with a default scene orientation and orientation of the apparatus differing by less than the threshold value.

The threshold value may be based on a quantization distance used to encode the orientation information.

The means configured to encode the orientation information may be configured to: determine a plurality of indexed elevation values and indexed azimuth values as points on a grid arranged in a form of a sphere, wherein the spherical grid is formed by covering the sphere with smaller spheres, wherein the smaller spheres define the points of the spherical grid; identify a reference orientation within the grid as a zero elevation ring; identify a point on the grid closest to a first selected direction index; apply a rotation based on the orientation information to a plane; identify a second point on the grid closest to the rotated plane; and encode the orientation information based on the point on the grid and the second point on the grid.

The means configured to obtain at least one audio scene may be configured to capture the at least one audio scene comprising the at least one audio signal.

The at least one audio scene may further comprise metadata associated with the at least one audio signal.

The means may be further configured to encode the metadata associated with the at least one audio signal. According to a second aspect there is provided an apparatus comprising means configured to: obtain an encoded at least one audio signal and encoded orientation information, wherein the at least one audio signal is part of an audio scene obtained by a further apparatus and the encoded orientation is associated with the further apparatus; decode the at least one audio signal; decode the encoded orientation information, wherein the orientation information comprises information associated with a default scene orientation and orientation of the further apparatus; and provide the decoded orientation information to means configured to signal process the at least one audio signal based on the default scene orientation and orientation of the further apparatus.

The orientation information may further comprise at least one of: orientation of a user operating the further apparatus; information indicating whether orientation compensation is being applied to the at least one audio signal by the further apparatus; an orientation reference; and orientation information identifying a global orientation reference.

The means configured to obtain the encoded orientation information may be for at least one of: once as part of an initialization procedure; on a regular basis determined by a time period; based on a user input requesting the orientation information; and based on a determined operation mode change of the further apparatus.

The means configured to decode the orientation information may be configured to perform at least one of: decode the orientation information based on a determination of a format of the encoded at least one audio signal; and decode the orientation information based on a determination of an available bit rate for the encoded orientation information.

The means configured to decode the orientation information may be configured to: determine whether there is separately encoded information associated with a default scene orientation and orientation of the further apparatus; decode both of the information associated with a default scene orientation and the orientation of the further apparatus based on the separately encoded information associated with a default scene orientation and orientation of the further apparatus; and determine the orientation of the further apparatus as the decoded information associated with a default scene orientation when there is only the encoded information associated with a default scene orientation present.

The means configured to decode the orientation information may be configured to: determine within the orientation information a first index representing a point on a grid of indexed elevation values and indexed azimuth values, and a second index representing a second point on the grid of indexed elevation values and indexed azimuth values, wherein the grid is arranged in a form of a sphere, wherein the spherical grid is formed by covering the sphere with smaller spheres, wherein the smaller spheres define the points of the spherical grid; identify a reference orientation within the grid as a zero elevation ring; identify a point on the grid closest to the first index on the zero elevation ring; identify a rotation by a plane on the zero elevation ring through the point on the grid closest to the first index which results in a rotating plane also passing through the second point on the grid; wherein the orientation information is the rotation.

The means configured to identify a rotation by a plane on the zero elevation ring through the point on the grid closest to the first index which results in a rotating plane also passing through the second point on the grid may be configured to: determine whether the second point is on the right-hand side or downwards of the first plane; and apply an additional rotation 180 degrees when the second point is on the right-hand side or downwards of the first plane.

The means may be further configured to signal process the at least one audio signal based on the default scene orientation and orientation of the further apparatus.

The means configured to signal process the at least one audio signal based on the default scene orientation and orientation of the further apparatus may be configured to: determine at least one orientation control user input or orientation control indicator; and apply an orientation compensation processing to the at least one audio signal based on the default scene orientation, orientation of the further apparatus and the at least one orientation control user input or orientation control indicator.

The means configured to signal process the at least one audio signal based on the default scene orientation and orientation of the further apparatus may be configured to: determine at least one scene rotation control user input; apply a scene rotation processing to the at least one audio signal based on the default scene orientation, orientation of the further apparatus and the at least one scene rotation user input.

The means may further be configured to obtain encoded metadata associated with the at least one audio signal.

The means may be further configured to decode metadata associated with the at least one audio signal.

The means configured to signal process the at least one audio signal based on the default scene orientation and orientation of the further apparatus may be configured to signal process the at least one audio signal further based on the metadata associated with the at least one audio signal.

According to a third aspect there is provided a method comprising: obtaining at least one audio scene comprising at least one audio signal; obtaining orientation information associated with the apparatus, wherein the orientation information comprises information associated with a default scene orientation and orientation of the apparatus; encoding the at least one audio signal; encode the orientation information; and outputting or storing the encoded at least one audio signal and encoded orientation information.

The orientation information may further comprise at least one of: orientation of a user operating the apparatus; information indicating whether orientation compensation is being applied to the at least one audio signal by the apparatus; an orientation reference; and orientation information identifying a global orientation reference.

Obtaining orientation information associated with the apparatus may comprise obtaining orientation information associated with the apparatus for at least one of: once as part of an initialization procedure; on a regular basis determined by a time period; based on a user input requesting the orientation information; and based on a determined operation mode change of the apparatus.

Encoding the orientation information may comprise performing at least one of: encoding the orientation information based on a determination of a format of the encoded at least one audio signal; and encoding the orientation information based on a determination of an available bit rate for the encoded orientation information.

Encoding the orientation information may comprise: comparing the information associated with a default scene orientation and orientation of the apparatus; encoding both of the information associated with a default scene orientation and the orientation of the apparatus based on the comparison of the information associated with a default scene orientation and orientation of the apparatus differing by more than a threshold value; and encode only the information associated with a default scene orientation based on the comparison of the information associated with a default scene orientation and orientation of the apparatus differing by less than the threshold value.

The threshold value may be based on a quantization distance used to encode the orientation information.

Encoding the orientation information may comprise: determining a plurality of indexed elevation values and indexed azimuth values as points on a grid arranged in a form of a sphere, wherein the spherical grid is formed by covering the sphere with smaller spheres, wherein the smaller spheres define the points of the spherical grid; identifying a reference orientation within the grid as a zero elevation ring; identifying a point on the grid closest to a first selected direction index; apply a rotation based on the orientation information to a plane; identifying a second point on the grid closest to the rotated plane; and encoding the orientation information based on the point on the grid and the second point on the grid. Obtaining at least one audio scene may comprise capturing the at least one audio scene comprising the at least one audio signal.

The at least one audio scene may further comprise metadata associated with the at least one audio signal.

The method may further comprise encoding the metadata associated with the at least one audio signal.

According to a fourth aspect there is provided a method comprising: obtaining an encoded at least one audio signal and encoded orientation information, wherein the at least one audio signal is part of an audio scene obtained by a further apparatus and the encoded orientation is associated with the further apparatus; decoding the at least one audio signal; decoding the encoded orientation information, wherein the orientation information comprises information associated with a default scene orientation and orientation of the further apparatus; and providing the decoded orientation information to means configured to signal process the at least one audio signal based on the default scene orientation and orientation of the further apparatus.

The orientation information may further comprise at least one of: orientation of a user operating the further apparatus; information indicating whether orientation compensation is being applied to the at least one audio signal by the further apparatus; an orientation reference; and orientation information identifying a global orientation reference.

Obtaining the encoded orientation information may comprise obtaining for at least one of: once as part of an initialization procedure; on a regular basis determined by a time period; based on a user input requesting the orientation information; and based on a determined operation mode change of the further apparatus.

Decoding the orientation information may comprise at least one of: decoding the orientation information based on a determination of a format of the encoded at least one audio signal; and decoding the orientation information based on a determination of an available bit rate for the encoded orientation information.

Decoding the orientation information may comprise: determining whether there is separately encoded information associated with a default scene orientation and orientation of the further apparatus; decoding both of the information associated with a default scene orientation and the orientation of the further apparatus based on the separately encoded information associated with a default scene orientation and orientation of the further apparatus; and determining the orientation of the further apparatus as the decoded information associated with a default scene orientation when there is only the encoded information associated with a default scene orientation present.

Decoding the orientation information may comprise: determining within the orientation information a first index representing a point on a grid of indexed elevation values and indexed azimuth values, and a second index representing a second point on the grid of indexed elevation values and indexed azimuth values, wherein the grid is arranged in a form of a sphere, wherein the spherical grid is formed by covering the sphere with smaller spheres, wherein the smaller spheres define the points of the spherical grid; identifying a reference orientation within the grid as a zero elevation ring; identifying a point on the grid closest to the first index on the zero elevation ring; identifying a rotation by a plane on the zero elevation ring through the point on the grid closest to the first index which results in a rotating plane also passing through the second point on the grid, wherein the orientation information is the rotation.

Identifying a rotation by a plane on the zero elevation ring through the point on the grid closest to the first index which results in a rotating plane also passing through the second point on the grid may comprise: determining whether the second point is on the right-hand side or downwards of the first plane; and applying an additional rotation 180 degrees when the second point is on the right-hand side or downwards of the first plane.

The method may further comprise signal processing the at least one audio signal based on the default scene orientation and orientation of the further apparatus.

Signal processing the at least one audio signal based on the default scene orientation and orientation of the further apparatus may comprise: determining at least one orientation control user input or orientation control indicator; and applying an orientation compensation processing to the at least one audio signal based on the default scene orientation, orientation of the further apparatus and the at least one orientation control user input or orientation control indicator.

Signal processing the at least one audio signal based on the default scene orientation and orientation of the further apparatus may comprise: determining at least one scene rotation control user input; applying a scene rotation processing to the at least one audio signal based on the default scene orientation, orientation of the further apparatus and the at least one scene rotation user input. The method may further comprise obtaining encoded metadata associated with the at least one audio signal.

The method may further comprise to decoding metadata associated with the at least one audio signal.

Signal processing the at least one audio signal based on the default scene orientation and orientation of the further apparatus may comprise signal processing the at least one audio signal further based on the metadata associated with the at least one audio signal.

According to a fifth aspect there is provided an apparatus comprising at least one processor and at least one memory including a computer program code, the at least one memory and the computer program code configured to, with the at least one processor, cause the apparatus at least to: obtain at least one audio scene comprising at least one audio signal; obtain orientation information associated with the apparatus, wherein the orientation information comprises information associated with a default scene orientation and orientation of the apparatus; encode the at least one audio signal; encode the orientation information; and output or store the encoded at least one audio signal and encoded orientation information.

The orientation information may further comprise at least one of: orientation of a user operating the apparatus; information indicating whether orientation compensation is being applied to the at least one audio signal by the apparatus; an orientation reference; and orientation information identifying a global orientation reference.

The apparatus caused to obtain orientation information associated with the apparatus may be caused to obtain orientation information associated with the apparatus for at least one of: once as part of an initialization procedure; on a regular basis determined by a time period; based on a user input requesting the orientation information; and based on a determined operation mode change of the apparatus.

The apparatus caused to encode the orientation information may be caused to perform at least one of: encode the orientation information based on a determination of a format of the encoded at least one audio signal; and encode the orientation information based on a determination of an available bit rate for the encoded orientation information.

The apparatus caused to encode the orientation information may be caused to: compare the information associated with a default scene orientation and orientation of the apparatus; encode both of the information associated with a default scene orientation and the orientation of the apparatus based on the comparison of the information associated with a default scene orientation and orientation of the apparatus differing by more than a threshold value; and encode only the information associated with a default scene orientation based on the comparison of the information associated with a default scene orientation and orientation of the apparatus differing by less than the threshold value.

The threshold value may be based on a quantization distance used to encode the orientation information.

The apparatus caused to encode the orientation information may be caused to: determine a plurality of indexed elevation values and indexed azimuth values as points on a grid arranged in a form of a sphere, wherein the spherical grid is formed by covering the sphere with smaller spheres, wherein the smaller spheres define the points of the spherical grid; identify a reference orientation within the grid as a zero elevation ring; identify a point on the grid closest to a first selected direction index; apply a rotation based on the orientation information to a plane; identify a second point on the grid closest to the rotated plane; and encode the orientation information based on the point on the grid and the second point on the grid.

The apparatus caused to obtain at least one audio scene may be caused to capture the at least one audio scene comprising the at least one audio signal.

According to a sixth aspect there is provided an apparatus comprising at least one processor and at least one memory including a computer program code, the at least one memory and the computer program code configured to, with the at least one processor, cause the apparatus at least to: obtain an encoded at least one audio signal and encoded orientation information, wherein the at least one audio signal is part of an audio scene obtained by a further apparatus and the encoded orientation is associated with the further apparatus; decode the at least one audio signal; decode the encoded orientation information, wherein the orientation information comprises information associated with a default scene orientation and orientation of the further apparatus; and provide the decoded orientation information to means configured to signal process the at least one audio signal based on the default scene orientation and orientation of the further apparatus.

The orientation information may further comprise at least one of: orientation of a user operating the further apparatus; information indicating whether orientation compensation is being applied to the at least one audio signal by the further apparatus; an orientation reference; and orientation information identifying a global orientation reference.

The apparatus caused to obtain the encoded orientation information may be caused to obtain the encoded orientation information for at least one of: once as part of an initialization procedure; on a regular basis determined by a time period; based on a user input requesting the orientation information; and based on a determined operation mode change of the further apparatus.

The apparatus caused to decode the orientation information may be caused to perform at least one of: decode the orientation information based on a determination of a format of the encoded at least one audio signal; and decode the orientation information based on a determination of an available bit rate for the encoded orientation information.

The apparatus caused to decode the orientation information may be caused to: determine whether there is separately encoded information associated with a default scene orientation and orientation of the further apparatus; decode both of the information associated with a default scene orientation and the orientation of the further apparatus based on the separately encoded information associated with a default scene orientation and orientation of the further apparatus; and determine the orientation of the further apparatus as the decoded information associated with a default scene orientation when there is only the encoded information associated with a default scene orientation present.

The apparatus caused to decode the orientation information may be caused to: determine within the orientation information a first index representing a point on a grid of indexed elevation values and indexed azimuth values, and a second index representing a second point on the grid of indexed elevation values and indexed azimuth values, wherein the grid is arranged in a form of a sphere, wherein the spherical grid is formed by covering the sphere with smaller spheres, wherein the smaller spheres define the points of the spherical grid; identify a reference orientation within the grid as a zero elevation ring; identify a point on the grid closest to the first index on the zero elevation ring; identify a rotation by a plane on the zero elevation ring through the point on the grid closest to the first index which results in a rotating plane also passing through the second point on the grid; wherein the orientation information is the rotation.

The apparatus caused to identify a rotation by a plane on the zero elevation ring through the point on the grid closest to the first index which results in a rotating plane also passing through the second point on the grid may be caused to: determine whether the second point is on the right-hand side or downwards of the first plane; and apply an additional rotation 180 degrees when the second point is on the right-hand side or downwards of the first plane.

The apparatus may be further caused to signal process the at least one audio signal based on the default scene orientation and orientation of the further apparatus.

The apparatus caused to signal process the at least one audio signal based on the default scene orientation and orientation of the further apparatus may be caused to: determine at least one orientation control user input or orientation control indicator; and apply an orientation compensation processing to the at least one audio signal based on the default scene orientation, orientation of the further apparatus and the at least one orientation control user input or orientation control indicator.

The apparatus caused to signal process the at least one audio signal based on the default scene orientation and orientation of the further apparatus may be caused to: determine at least one scene rotation control user input; apply a scene rotation processing to the at least one audio signal based on the default scene orientation, orientation of the further apparatus and the at least one scene rotation user input.

According to a seventh aspect there is provided an apparatus comprising: obtaining circuitry configured to obtain at least one audio scene comprising at least one audio signal; obtaining circuitry configured to obtain orientation information associated with the apparatus, wherein the orientation information comprises information associated with a default scene orientation and orientation of the apparatus; encode the at least one audio signal; encoding circuitry configured of encode the orientation information; and outputting circuitry configured to output, or storing circuitry configured to store, the encoded at least one audio signal and encoded orientation information.

According to an eighth aspect there is provided an apparatus comprising: obtaining circuitry configured to obtain an encoded at least one audio signal and encoded orientation information, wherein the at least one audio signal is part of an audio scene obtained by a further apparatus and the encoded orientation is associated with the further apparatus; decoding circuitry configured of decode the at least one audio signal; decoding circuitry configured to decode the encoded orientation information, wherein the orientation information comprises information associated with a default scene orientation and orientation of the further apparatus; and providing circuitry configured to provide the decoded orientation information to means configured to signal process the at least one audio signal based on the default scene orientation and orientation of the further apparatus.

According to a ninth aspect there is provided a computer program comprising instructions [or a computer readable medium comprising program instructions] for causing an apparatus to perform at least the following: obtaining at least one audio scene comprising at least one audio signal; obtain orientation information associated with the apparatus, wherein the orientation information comprises information associated with a default scene orientation and orientation of the apparatus; encoding the at least one audio signal; encode the orientation information; and outputting or storing the encoded at least one audio signal and encoded orientation information.

According to a tenth aspect there is provided a computer program comprising instructions [or a computer readable medium comprising program instructions] for causing an apparatus to perform at least the following: obtaining an encoded at least one audio signal and encoded orientation information, wherein the at least one audio signal is part of an audio scene obtained by a further apparatus and the encoded orientation is associated with the further apparatus; decoding the at least one audio signal; decode the encoded orientation information, wherein the orientation information comprises information associated with a default scene orientation and orientation of the further apparatus; and providing the decoded orientation information to means configured to signal process the at least one audio signal based on the default scene orientation and orientation of the further apparatus.

According to an eleventh aspect there is provided a non-transitory computer readable medium comprising program instructions for causing an apparatus to perform at least the following: obtaining at least one audio scene comprising at least one audio signal; obtain orientation information associated with the apparatus, wherein the orientation information comprises information associated with a default scene orientation and orientation of the apparatus; encoding the at least one audio signal; encode the orientation information; and outputting or storing the encoded at least one audio signal and encoded orientation information.

According to a twelfth aspect there is provided a non-transitory computer readable medium comprising program instructions for causing an apparatus to perform at least the following: obtaining an encoded at least one audio signal and encoded orientation information, wherein the at least one audio signal is part of an audio scene obtained by a further apparatus and the encoded orientation is associated with the further apparatus; decoding the at least one audio signal; decode the encoded orientation information, wherein the orientation information comprises information associated with a default scene orientation and orientation of the further apparatus; and providing the decoded orientation information to means configured to signal process the at least one audio signal based on the default scene orientation and orientation of the further apparatus.

According to a thirteenth aspect there is provided an apparatus comprising: means for obtaining at least one audio scene comprising at least one audio signal; obtain orientation information associated with the apparatus, wherein the orientation information comprises information associated with a default scene orientation and orientation of the apparatus; means for encoding the at least one audio signal; encode the orientation information; and means for outputting or storing the encoded at least one audio signal and encoded orientation information.

According to a fourteenth aspect there is provided an apparatus comprising: means for obtaining an encoded at least one audio signal and encoded orientation information, wherein the at least one audio signal is part of an audio scene obtained by a further apparatus and the encoded orientation is associated with the further apparatus; means for decoding the at least one audio signal; means for decode the encoded orientation information, wherein the orientation information comprises information associated with a default scene orientation and orientation of the further apparatus; and providing the decoded orientation information to means configured to signal process the at least one audio signal based on the default scene orientation and orientation of the further apparatus.

According to a fifteenth aspect there is provided a computer readable medium comprising program instructions for causing an apparatus to perform at least the following: obtaining at least one audio scene comprising at least one audio signal; obtain orientation information associated with the apparatus, wherein the orientation information comprises information associated with a default scene orientation and orientation of the apparatus; encoding the at least one audio signal; encode the orientation information; and outputting or storing the encoded at least one audio signal and encoded orientation information.

According to a sixteenth aspect there is provided a computer readable medium comprising program instructions for causing an apparatus to perform at least the following: obtaining an encoded at least one audio signal and encoded orientation information, wherein the at least one audio signal is part of an audio scene obtained by a further apparatus and the encoded orientation is associated with the further apparatus; decoding the at least one audio signal; decode the encoded orientation information, wherein the orientation information comprises information associated with a default scene orientation and orientation of the further apparatus; and providing the decoded orientation information to means configured to signal process the at least one audio signal based on the default scene orientation and orientation of the further apparatus.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows a various degree of freedom based rendering schemes;

FIGS. 2 and 3 show schematically a typical audio capture scenario which may be experienced when employing a mobile device;

FIG. 4a shows orientations to be considered for providing a listener control of captured audio signals;

FIG. 4b shows an example of the device orientation changing due to user movement and mode of use change;

FIG. 4c shows example orientations to be considered for providing a listener control of captured audio signals within the context of the user movement and mode of use change as shown in FIG. 4b;

FIG. 5 shows an example user rotation with the capture device located on the ear of a user;

FIGS. 6a and 6b show an example orientation sequence;

FIGS. 7 and 8 show example orientation sequences during capture with two compensation modes;

FIG. 9 shows an example IVAS codec data path according to some embodiments;

FIG. 10 shows a flow chart of operations of the example IVAS codec data path as shown in FIG. 9 according to some embodiments;

FIG. 11 shows a flow chart of encoder operations of the example IVAS codec data path as shown in FIG. 9 according to some embodiments;

FIG. 12 shows a flow chart of decoder/renderer operations of the example IVAS codec data path as shown in FIG. 9 according to some embodiments;

FIGS. 13 and 14 show examples of orientation using spherical indexing;

FIG. 15 shows example tables; and

FIG. 16 shows an example device suitable for implementing the apparatus shown in previous figures.

### EMBODIMENTS OF THE APPLICATION

The following describes in further detail suitable apparatus and possible mechanisms for an improved orientation signalling for user-controlled spatial audio rendering.

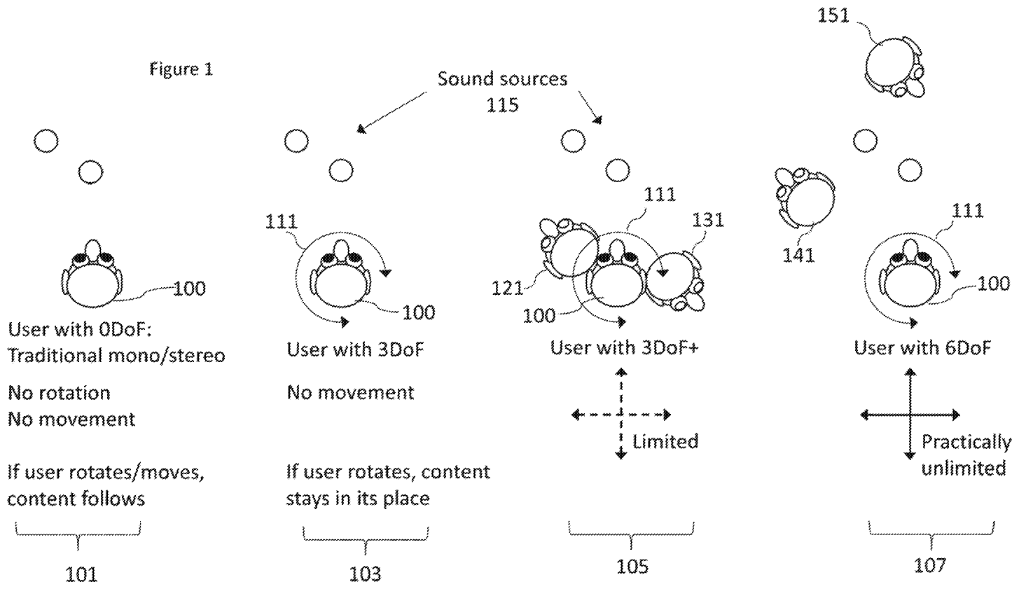

With respect to FIG. 1 there are shown examples demonstrating degrees of freedom in terms of user orientation/motion and with respect to audio rendering effects.

In terms of the audio capture, the same degrees of freedom may be at play in various use cases. An audio capture device may be static, or it may intentionally or at least partially unintentionally moved in the capture scene and/or rotated along its three axes.

Thus for example FIG. 1 shows a conventional headphone listening 101 operation where the traditional mono/stereo/multi-channel audio does not generally provide any externalization and playback does not allow for any “interaction”. In other words the sound sources 115 are fixed relative to user 100 regardless of any user movement. A head-locked audio with externalization (binauralization, e.g., using HRTFs) operates the same in terms of user orientation. Thus, there is no rotation or movement interaction and if the user rotates or moves the content follows.

So-called 3DoF (degrees-of-freedom) audio 103 allows for the audio sources to remain in their spatial positions when user 100 rotates 111 their head. A head-tracking system translates the user's head movement into suitable rendering orientation information, and the audio playback is adapted accordingly. Thus, there is no movement interaction (only rotation interaction) and if the user moves the content follows but if the user rotates the rendering of the content compensates for the rotation. Additionally, it can be considered combinations of dietic and non-dietic audio, where some content stays in place regardless of the user's head rotation and other content follows the user's head rotation. For example, in some embodiments it can be signalled that a user's voice signal that may be captured, e.g., by at least one microphone on a mobile device is maintained in a static position relative to a listener's head, while a spatial audio scene representation that may be captured, e.g., by an array of at least three microphones on a mobile device (where the at least one microphone used to capture the user's voice may or may not be part of said microphone array) follow's the listener's head rotation.

User's translational movement can furthermore be supported at varying levels. For example an implementation may be 3DoF+ 105 when user 100 is able to move as shown by the moved user 121, 131 in the audio scene by some limited amount. Thus, there is limited movement interaction (as well as unlimited rotation interaction) and if the user moves the content rendering compensates to some degree and if the user rotates the rendering of the content compensates for the rotation. In some instances it may be considered 3DoF+ where user's translational movement is considered to the degree of how much user movement is possible while sitting in a chair which cannot move.

6DoF 107 is typically reserved to describe playback where user movement is effectively or substantially unlimited. In practical terms, one example difference between 3DoF+ and 6DoF implementation can be that in 6DoF systems the user 100 is able to move into an overlap region with an audio source or, e.g., move around individual audio sources such as shown in FIG. 1 by the representations of the user at positions 141 and 151. Use cases such as augmented reality (AR) may thusly be considered mainly in the scope of 6DoF.

When spatial audio capture is considered, a capture device that moves in a scene creates a listening sensation of the listening point changing. When a rotation is applied to the capture device, this results in a rotation of the sound scene around the user. This can of course be intentional. In many cases the scene rotation can be confusing to the user and even create discomfort. Therefore, it is common to consider compensating for any scene rotation prior to encoding/transmission. The target in that case will be a scene without rotations or with intended rotations only.

For example, a capturing user could indicate on a device UI whether they wish for the rotations to be corrected.

Furthermore with respect to MPEG-I 6DoF Audio can feature a social VR aspect. This relates to communications voice and capture/transmission of other locally captured audio from a first user to at least a second user. Any capture-related orientation changes as discussed thus have relevance also for the MPEG-I standard.

Furthermore the IVAS decoder/renderer could in some situations be configured to decode and render more than one stream (from more than one source/encoder). This has certain implications which are addressed below.

The embodiments discussed in detail below attempt to define apparatus and methods for spatial audio capture which allow for full control of the spatial audio rendering orientation such that the renderer/rendering user is able to decide whether the rendered orientation is the audio scene orientation intended by the transmitting end, the audio scene orientation as captured, or the preferred listening orientation as specified by the renderer.

The embodiments therefore relate to spatial audio capture in a real-world environment, where the capture point may change (translational movement) and/or the capture orientation may change (rotational movement). This is particularly relevant in practical conversational use cases and for capture of user-generated content (UGC) in scenarios targeting mobile voice and audio. Whereas professional content capture is often pre-planned and generally strives for maximum quality by design, consumer audio capture is less strictly monitored/controlled and often revolves around other tasks performed by the user (sometimes limiting the quality of the capture, where the only monitoring is a receiving user providing verbal instructions such as “could you please repeat” or “can you go a little closer”).

Thus, while the professional content capture point translations and rotations are typically planned and/or intended, the non-professional use cases often exhibit more random movements. For example, a user may be walking on the street with the mobile device (user equipment, UE) on their ear, take turns at street corners, or rotate their head (with UE still on ear) to check for traffic or shop windows or just glance at the user's own feet. The capture orientation thus may change in random ways that in general are not of interest for the renderer.

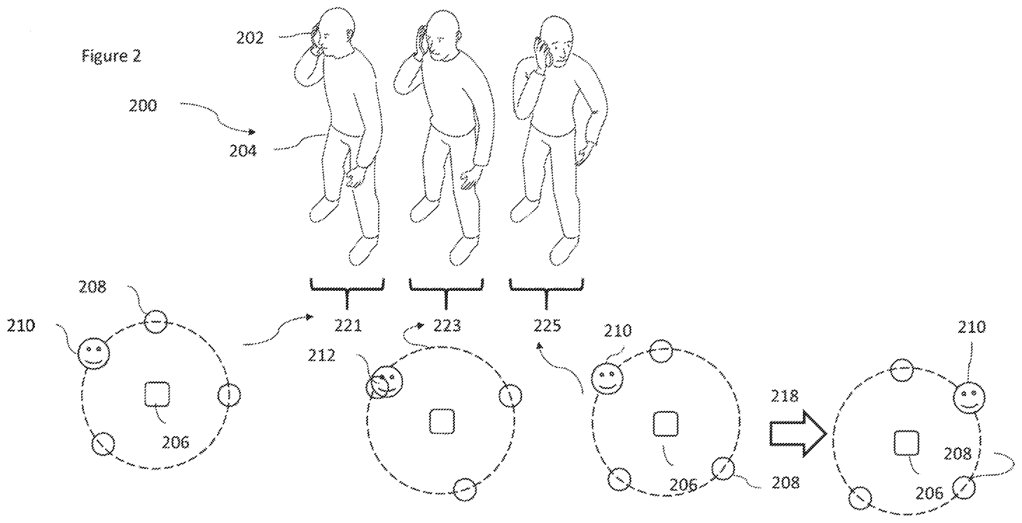

FIG. 2 for example shows a typical audio capture scenario 200 on a mobile device. In this example there is a first user 204 who does not have headphones with them. Thus, the user 204 makes a call with UE 202 on their ear. The user may call a further user 206 who is equipped with stereo headphones and therefore is able to hear spatial audio captured by the first user using the headphones. Based on the first user's spatial audio capture, an immersive experience for the second user can be provided. Considering, e.g., regular MASA capture and encoding, it can however be problematic that the device is on the capturing user's ear. For example, the user voice may dominate the spatial capture reducing the level of immersion. Also, all the head rotations by the user as well as device rotations relative to the user's head result in audio scene rotations for the receiving user. This may provide user confusion in some cases. Thus for example at time 221 the spatial audio scene captured is a first orientation as shown by the rendered sound scene from the experience of the further user 206 which shows the first user 210 at a first position relative to the further user 206 and one audio source 208 (of the more than one audio source in the scene) ata position directly in front of the further user 206. Then as the user turns their head at time 223 and turns further at time 225 then the captured spatial scene rotates which is shown by the rotation of the audio source 208 relative to the position of the further user 206 and the audio position of the first user 210. This for example could cause an overlapping 212 of the audio sources. Furthermore if the rotation is compensated, shown by arrow 218 with respect to the time 225, using the user device's sensor information, then the position of the audio source of the first user (the first user's voice) rotates the other way, making the experience less consistent and therefore potentially worse.

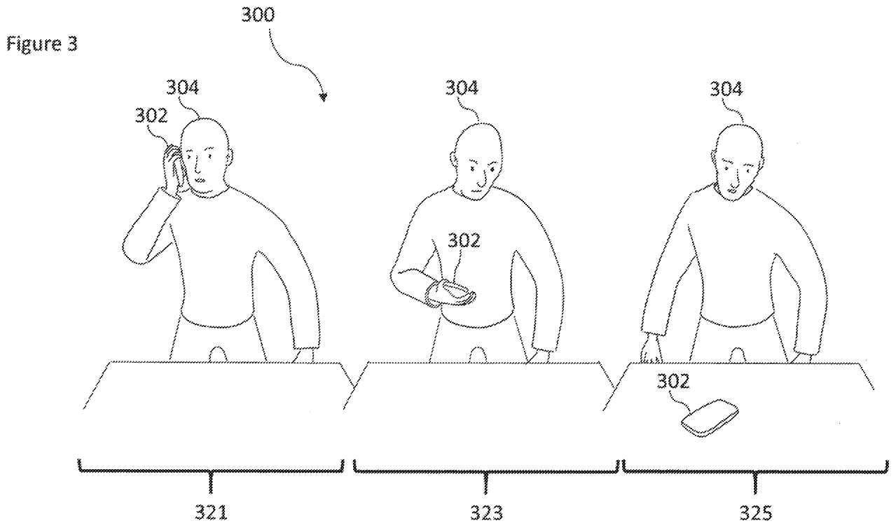

FIG. 3 shows a further audio capture scenario 300 using a mobile device. The user 304 may, e.g., begin (as seen on the left 321) with the UE 302 operating in handset mode, i.e., UE-on-ear capture mode and then change to a hands-free mode (which may be, e.g., handheld hands-free as shown at the centre 323 of FIG. 3 or UE/device 202 placed on table as shown on the right 325 of FIG. 3). The further user/listener may also wear earbuds or headphones for the presentation of the captured audio signals. In this case, the listener/further user may walk around in handheld hands-free mode or, e.g., move around the device placed on table (in hands-free capture mode). In this example use case the device rotations relative to the user voice position and the overall immersive audio scene are significantly more complex than in the case of FIG. 2, although this is similarly a fairly simple and typical use case for practical conversational applications.

The embodiments as discussed herein attempt to provide an improved orientation signalling for user-controlled spatial audio rendering. The embodiments thus consider signalling of capture device orientation to allow for rendering orientation adaptation within a signalling framework for controlling the full freedom of orientation change between capture and user-controlled presentation. Furthermore the embodiments as discussed herein allow for synchronization of more than one scene where necessary. In some embodiments it is furthermore possible to undo or remove a compensation applied prior to encoding (or during the encoding) according to a negative orientation change signal. The result of which may not derive exactly the uncompensated original captured audio signals but an approximation where accuracy is dependent on the orientation data quantization step size at the specific operation point being used.

In some embodiments the apparatus and method are for IVAS defined orientation information such as:
1. Default scene orientation for presentation
2. Orientation compensation on/off
3. Orientation information of the capturing device

In some embodiments in order to take into account synchronization of more than one scene in a virtual environment, the apparatus/methods are configured to signal the global orientation defining how the scene is oriented relative to other scenes. For example, it may be considered by more than one scene a combination of at least two meeting rooms into a virtual meeting place or a mixing of a real audio capture with a spatial audio scene derived from a file (such as for example a spatial music background).

In some embodiments a single orientation can be encoded as two points on the spherical index unit sphere. In some embodiments the first point provides the direction, and the second point provides the rotation around the first point. In some embodiments a default orientation, orientation compensation flag, and capturing device orientation information can be encoded as 4 points (e.g., on a unit sphere or as spherical indices) and one flag (denoting whether rotation compensation is used or not). If 3D rotation is not used, then only 2 points defining the orientations (azimuth) are required in some embodiments.

In some embodiments the various signalling methods as discussed herein can be adopted in the context of the IVAS standard as an SDP/RTP feature or as an in-band feature or as a combination thereof to provide the orientation signalling feature. For example, orientation signalling can be session metadata set relative to the at least one encoder instance for an upstream transmission. Alternatively and in addition, some session- or service-specific aspects may furthermore be signalled in downstream transmission or otherwise provided to an decoder/renderer only. For example, a teleconferencing server that collects many audio inputs and provides a downstream mix or other combination thereof may provide such metadata signalling or settings for at least one decoder/renderer instance. In any implementation where a decoder/renderer is capable of combining more than one incoming (bit)stream, such additional signalling may be provided by any suitable external service or application.

In some embodiments the apparatus can be a mobile capture device (e.g., a multi-microphone mobile device) implementing an immersive audio codec for immersive audio services. Furthermore the apparatus is able to provide the rotation tracking data to the encoder interface and the encoder implementation. In some embodiments the apparatus may implement a telecommunications service (i.e., an immersive two-party or multi-party call) or may implement an immersive audio/media streaming service (e.g., for capture and delivery of user-generated content). The codec implemented by the apparatus may in some embodiments be, e.g., the 3GPP IVAS codec or a suitable communications-capable immersive audio codec. In some embodiments as described in further detail herein signalling for encoding or decoding/rendering can be implemented in a codec standard (such as 3GPP IVAS). The signalling can be at least partly implemented in SDP, RTP, or in-band.

The apparatus and methods as discussed herein are configured such that they can identify orientations that a capturing and transmitting spatial audio system should consider in order to be capable of fully implementing a correct acoustical reproduction with immersive interaction for the listener. In some embodiments these could be:
1. Default scene orientation for presentation
2. Orientation information of the capturing device.

Optionally a third orientation may be an orientation compensation on/off and a further optional orientation of the global rotation can be identified and signalled.

These two, three or four orientations thus describe a full set of orientations relating to the user experience under some circumstances and use cases.

Furthermore, it can be considered at least four orientations that describe the full extent of diverse use cases: user orientation, device orientation, scene orientation, and global orientation.

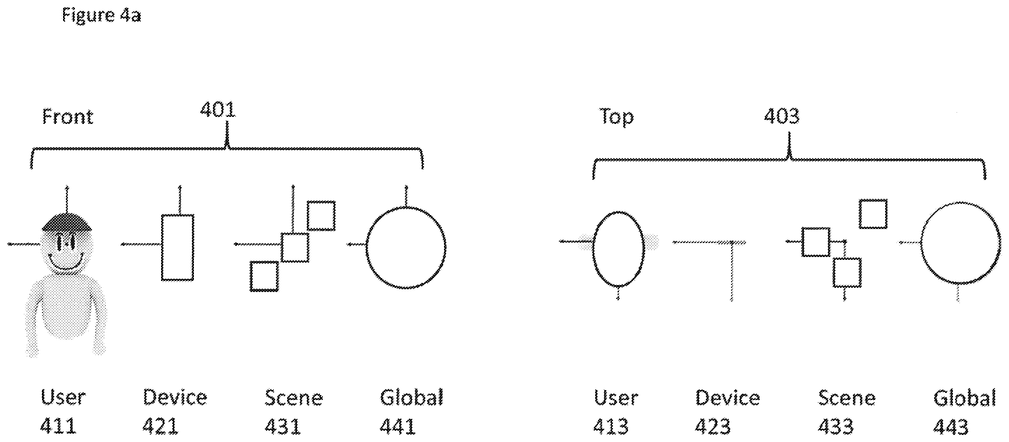

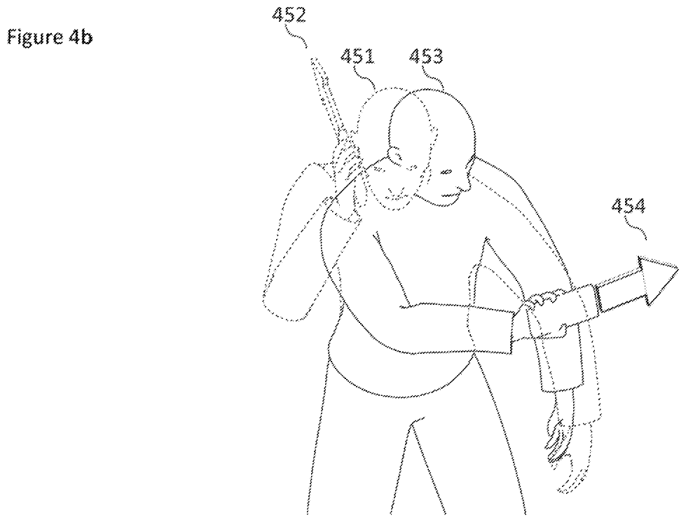

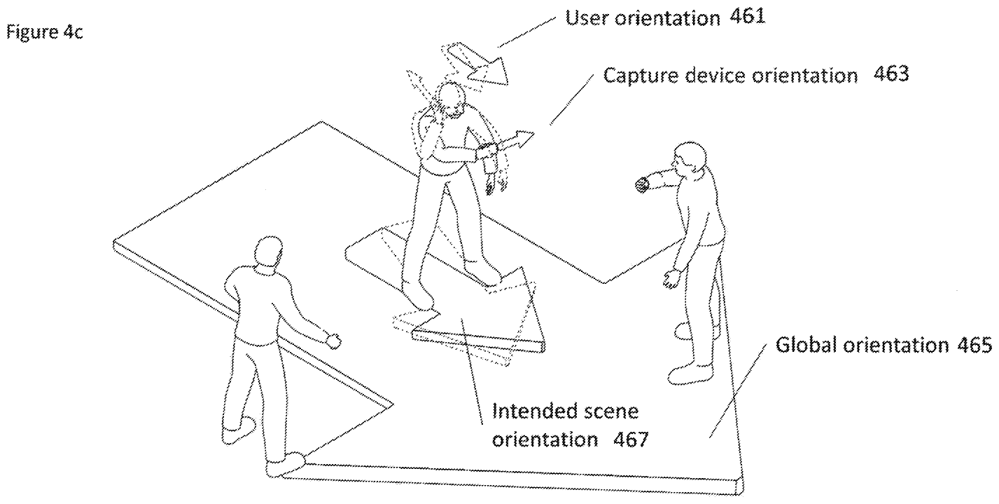

With respect to FIG. 4a is shown these orientations. In the following examples the orientations (typically understood as rotation) are described. However in some embodiments and examples location/position information (e.g., x-y-z coordinates) can be included. Thus for example throughout the description orientation is used which may in some embodiments comprise at least one of rotation and position information.

The four orientations relating to the local/transmitted scene shown in FIG. 4a are shown with respect to a front or elevation view 401 and a top or plan view 403:
1. Global orientation. This is shown in FIG. 4a by references 441 and 443 and can be representative of the world coordinate system or any service high-level coordinate system that can be considered for the placement and orientation of content. For example, it could be combined inputs (e.g., audio streams) from various geographical or user locations or users based on their GPS location data and orientation or to achieve a specific virtual constellation based on the combined inputs. It is understood a mapping from the GPS location to a global orientation would be performed for the placement in the virtual environment.
2. Audio scene orientation. This is shown in FIG. 4a by references 431 and 433 and represents the orientation of the audio scene that is captured, transmitted, and rendered. It can be described relative to a global orientation or relative to the audio format. For example, this can be understood as providing information such as default front for rendering. In a typical legacy content (e.g., 5.1 premixed content), the audio scene orientation is given by the channel layout only, where for example the centre channel (C) corresponds to the front. In combination with the global orientation it would then be possible to rotate the scene into the desired orientation for rendering (even relative to other contents). Otherwise any choice of orientation may be considered arbitrary and may be unintended from the capture device or transmitting side's viewpoint and conflict with at least one other transmitted audio scene or part thereof.
3. Capture device/system orientation. This is shown in FIG. 4a by reference 421 and 423 and represents the orientation of the capture device or microphone array. The device provides a captured audio scene according to some audio representation (e.g., channel-based, MASA, etc.). If no additional information is provided or if no compensation is done, any capture device orientation change basically results in a re-orientation of the audio scene (as captured/rendered). This type of change may be intended or unintended.
4. Capturing user orientation. This is shown in FIG. 4a by reference 411 and 413 and represents the orientation of the user relative to the audio scene. While in some cases the capturing user orientation is of no interest for the scene understanding and rendering, in others it can be of great interest. For example, in some implementations of a UE spatial capture, the capturing user orientation may be indicative of whether capture device orientation is part of the scene interpretation or “accidental”. It can be noted that for head-worn AR device spatial capture, the capturing user orientation and the capture device orientation are typically the same (at least for current device form factors). Furthermore, capturing user orientation may be disconnected of the device orientation in some capture modes. User orientation can also be of interest for 6DoF scene rendering, where a virtual user (avatar) orientation may be based on the real capturing user orientation. One potential such system is, e.g., Social VR in the scope of MPEG-I 6DoF Audio. In addition to linking an avatar orientation to user orientation, at least some aspects of the audio rendering, e.g., directivity, may depend on capturing user orientation.

The embodiments as described herein are configured such that there is a mapping between the capture device orientation and the audio scene orientation. Although it may appear that device orientation signalling defines this it does not specify this mapping fully. Specifically it does not describe the mapping between the audio scene rotation and the global orientation. Nor does it describe the change of that mapping or any other change of the audio scene rotation. In order to enable a renderer or processor control of the orientation changes and compensation the mappings with respect to all the interconnections should be defined. Thus in the embodiments as described herein these relationships are defined and signalling methods further defined to pass this information to a suitable processor or renderer.

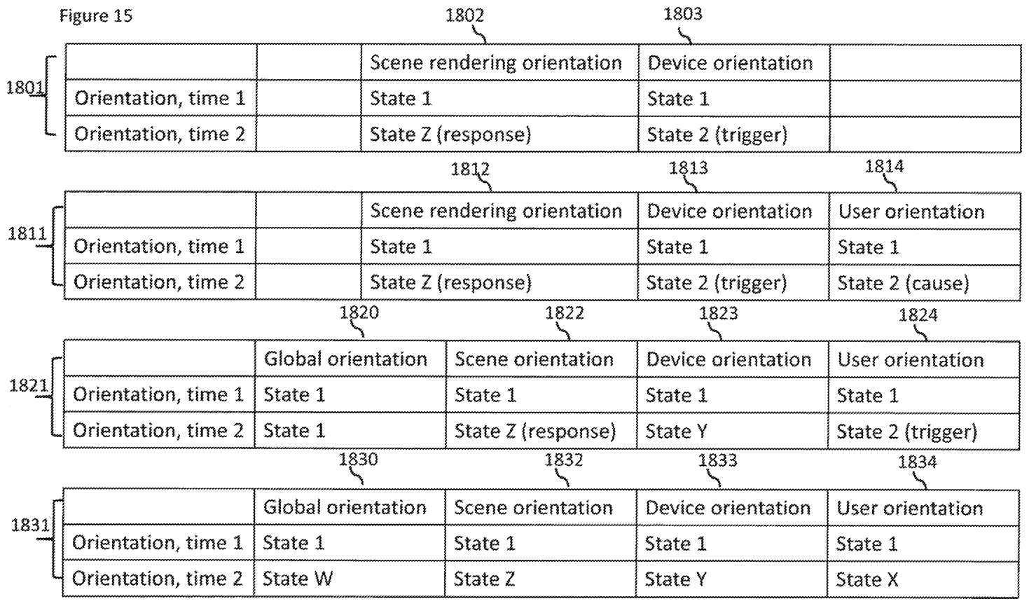

A conventional device orientation signalling may for example be shown with respect to the first table 1801 in FIG. 15 wherein each row describes a time instance, for example orientation time 1 and orientation time 2. There is also shown a first column 1802 which describes a scene rendering orientation, for example state 1 at time 1, and state z (response) at time 2 and a second column 1803 which describes a device orientation, for example state 1 at time 1 and state 2 (trigger) at time 2.

In such a manner a change in device orientation can be signalled and may allow for updating of the scene orientation in the rendering but does not describe the original scene orientation in any way. It can be generally understood that the device orientation change is often due to user movement/orientation change. Thus with respect to the second table 1811 in FIG. 15 the change in user orientation above could also be defined. The second table 1811 shows each row describing a time instance, for example orientation time 1 and orientation time 2, a first column 1812 which describes a scene rendering orientation, for example state 1 at time 1, and state z (response) at time 2, a second column 1813 which describes a device orientation, for example state 1 at time 1 and state 2 (trigger) at time 2 and a third column 1814 which describes a user orientation, for example state 1 at time 1 and state 2 (cause) at time 2.

With respect to FIG. 4b is shown an example change of the device orientation based on the user movement and change of mode of use. For example the dotted outline 451 shows a user first operating the device in a handset mode when the device orientation has a first orientation 452. The solid outline 453 shows the user having moved (rotated) and operating the device in a handsfree mode of operation. When used in this mode and with the user rotated the device has a different orientation 454.

With respect to FIG. 4c is shown the example in FIG. 4b where the user is shown in context with the global orientation 465, which does not change with the user orientation change and mode change, the intended scene orientation 467 which may change due to the user orientation change and mode change, and the capture device orientation 463 which may change due to the user orientation change and mode change and the user orientation 461 change itself.

In some embodiments, at least one of user orientation and intended scene orientation; or device orientation and intended scene orientation may be linked. Alternatively and in addition, the user may control the intended scene orientation, e.g., via a dedicated user interface, a secondary device or orientation sensors, and/or by switching an automatic capture-time device orientation compensation on/off. The global orientation is typically not dependent of the sound scene being captured or user action during the capture. For example, it may be provided by the service to which the user device connects, e.g., to provide means for combining audio scene streams from multiple captures in a controlled manner (e.g., such that scene orientations between multiple receiving users are consistent).

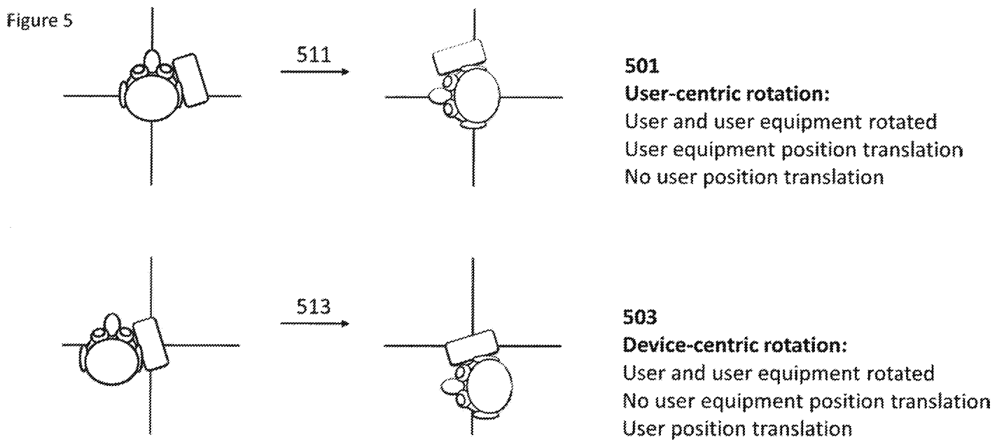

With respect to FIG. 5 is shown a suitable use or implementation which is similar to a traditional UE use or implementation, where the user has the terminal in handset mode, i.e., located on their ear during a voice call. In this example the capture is a spatial capture (not mono), and it is therefore of interest to determine at least the orientation of the capturing device relative to the sound sources. On the other hand, the user is likely listening to a mono audio themselves (as they have the UE on one ear).

In this example the user holds the device steadily during any movement. Therefore, the UE alignment with user's ear and mouth is kept constant. In this example the rotation can be, e.g., user-centric such as shown in FIG. 5 by the top row 501, where any rotation 511 is centred on the user (a 90-degree rotation is illustrated) and applies a similar rotation also for the UE. However, due to the UE located on the user's ear, there is some translation applied to the UE position in addition to the rotation. The rotation could be also, e.g., device-centric such as shown in FIG. 5 by the bottom row 503, where the rotation 513 is seen to happen around an axis through the device (the device itself is rotated here due to the user pose, but this rotation remains fixed). A similar 90-degree rotation is now seen to result in a translational movement for the user instead.

In practical terms, there are use cases where there is a strong correlation between the orientation change of the user and the UE, however these are generally never exactly the same. However emerging head-worn AR device category are likely to exhibit a more direct (and substantially fixed) correlation between the user orientation and capture device orientation. In many cases, the capturing user orientation can be understood as the user's head orientation, however that need not be the case. For example, body tracking may be applied in some use cases and capture systems. Therefore, in some embodiments the capturing user orientation may be defined, e.g., both in terms of head orientation and torso/body/overall orientation.

Where user tracking is implemented, the (capturing) user orientation may in some use cases determine the intended spatial scene orientation. For example, the orientation of the user (the direction in which the user is facing) may define the intended front of the audio scene. The spatial audio capture orientation may in this case be static, or the capture orientation may otherwise be independent of the user orientation (e.g., based on the head rotation as described above or any other UE rotation). In other words, the two may change independently, where the user orientation drives the scene orientation.

Thus with respect to the third table 1821 in FIG. 15 the global orientation could also be defined. The third table 1821 shows each row describing a time instance, for example orientation time 1 and orientation time 2, a first column 1820 which describes a global orientation, for example state 1 at time 1, and state 1 at time 2, a second column 1822 which describes a scene rendering orientation, for example state 1 at time 1, and state z (response) at time 2, a third column 1823 which describes a device orientation, for example state 1 at time 1 and state 2 (trigger) at time 2 and a fourth column 1824 which describes a user orientation, for example state 1 at time 1 and state 2 (cause) at time 2.

In some embodiments where there is orientation signalling for the decoder/renderer then a full control of the scene rendering and placement relative to other content is allowed by suitable signalling. Otherwise, the signalling is relevant only for a small subset of possible use cases of interest. This for example can be implemented by signalling the global orientation such as shown with respect to the fourth table 1831 in FIG. 15. The fourth table 1831 shows each row describing a time instance, for example orientation time 1 and orientation time 2, a first column 1830 which describes a global orientation, for example state 1 at time 1, and state W at time 2, a second column 1832 which describes a scene rendering orientation, for example state 1 at time 1, and state z at time 2, a third column 1833 which describes a device orientation, for example state 1 at time 1 and state y at time 2 and a fourth column 1834 which describes a user orientation, for example state 1 at time 1 and state x at time 2.

In other words, in such embodiments every orientation component identified here (global, scene, device, user) is independently signalled in order to enable full encoder-guided rendering control of the acoustical reproduction of the spatial audio scene. In some embodiments, for practical reasons, there may be implemented signalling methods which are sub-sets of the information signalled in the fully defined scheme. For example, in some embodiments, the capturing and signalling of user orientation may be of little or no practical use.

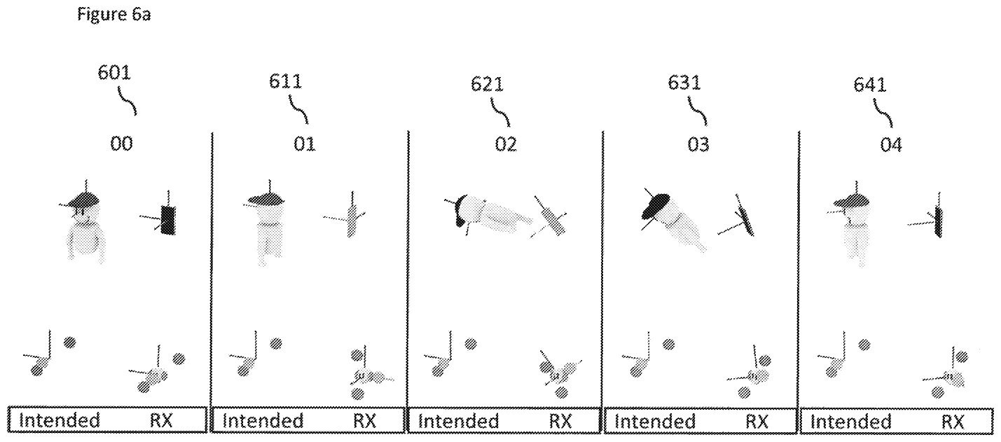

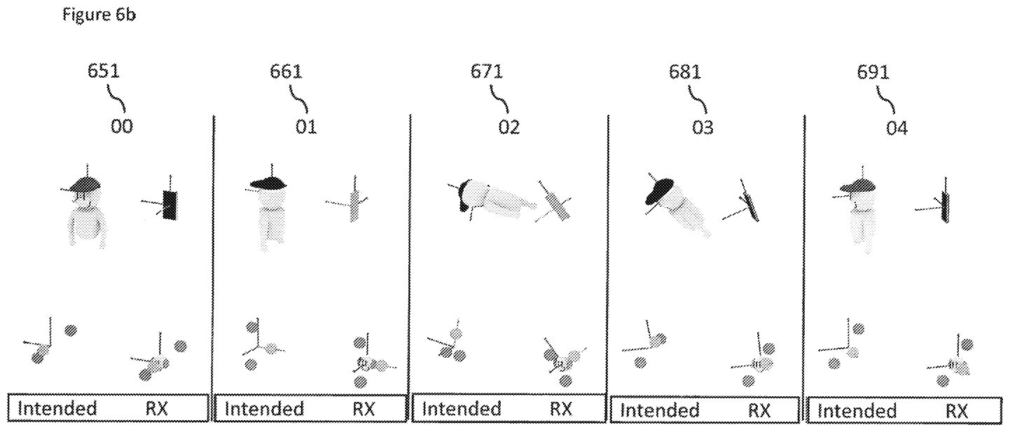

With respect to FIGS. 6a and 6b are shown two example orientation sequences that demonstrate different transmitting (transmit, TX) side preferences in terms of the scene orientation and the experience as presented to a receiving (receive, RX) user.

In these examples the global orientation and audio scene orientation are fixed, and no orientation rotation compensation is applied at the capture device. It is in such examples possible that the device orientation corresponds to the intended orientation. In that case, there is no problem. It is also possible that the audio scene orientation corresponds to the intended orientation. The resulting issue is shown in FIG. 6a. On the other hand, it could also be possible that the user orientation would correspond to the intended orientation. This option and the resulting issue are shown in FIG. 6b.

In this example, FIG. 6a shows user orientation changes between a base or reference state 00 601, and a ‘90 degrees yaw right’ state 01 611, a ‘40 degrees pitch forward’ state 02 621, a ‘45 degrees yaw left’ state 03 631 and ‘40 degrees pitch backward’ state 03 631. Similarly 6b shows user orientation changes between a base or reference state 00 651, and a ‘90 degrees yaw right’ state 01 661, a ‘40 degrees pitch forward’ state 02 671, a ‘45 degrees yaw left’ state 03 681 and ‘40 degrees pitch backward’ state 03 691.

In these examples the device orientation for yaw follows the user orientation. For pitch, it is assumed that the user (who is leaning their head) manipulates the device orientation by keeping it closer to original orientation. The 40-degree user changes are thus, e.g., only 20 degrees for the device. This demonstrates that user and device rotation may or may not be the same in various example cases.

Thus, for FIG. 6a all orientation changes result in an incorrect presentation (this is shown in FIG. 6a in that the audio sources in the ‘intended’ view and the and audio sources for the received or rendered ‘RX’ view do not match). In the examples shown in FIG. 6b, the difference between the two are generally closer but do not match. This shows that the render or the user or apparatus receiving the audio signals should be configured to receive information about both the intended scene and the orientation information of the capture device configured to ‘contribute’ to the scene in order to be able to render the audio signals correctly.

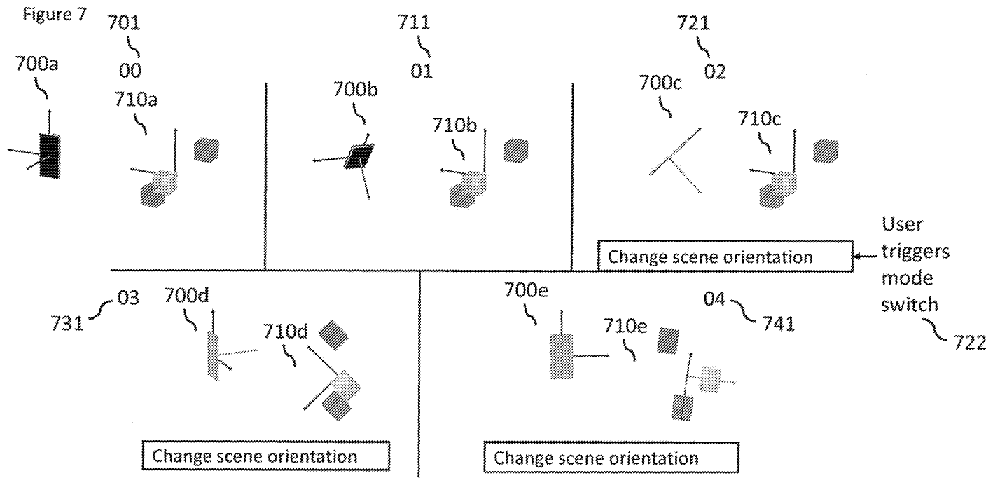

FIG. 7 shows a further orientation sequence. In this sequence the capture device only is considered and it is shown on the left hand side of each element of the sequence a position of the capture device shown by the user equipment 700 and on the right hand side of each element a representation of the audio scene 710. In this example the orientation of the capture device changes over time. FIG. 7 for example shows how a capture device orientation changes between a base or reference state 00 701 where the user device 700a has a base orientation, and a first rotation state 01 711 where the user device 700b has a first rotation orientation and a second rotation state 02 721 where the user device 700c has a second rotation orientation. In this example during these rotations the capture device is configured to perform a rotation compensation. Thus, the default scene orientation 710a is maintained 710b and 710c (in other words the audio scenes 710a, 710b and 710c match) despite the device orientation changing. At 02, the capture device (or user operating the device) switches modes 722. Orientation compensation is no more applied, and thus the scene changes its orientation according to the device orientation change. However, it is done according to the offset as observed at 02. Thus, the device and scene orientations do not match (they were initialized as the same in 00 for illustration purposes). Thus for example where there is a third rotation state 03 731 where the user device 700c has a third rotation orientation and a fourth rotation state 04 741 where the user device 700e has a fourth rotation orientation then the respective scene orientations 710d and 710e do not match.

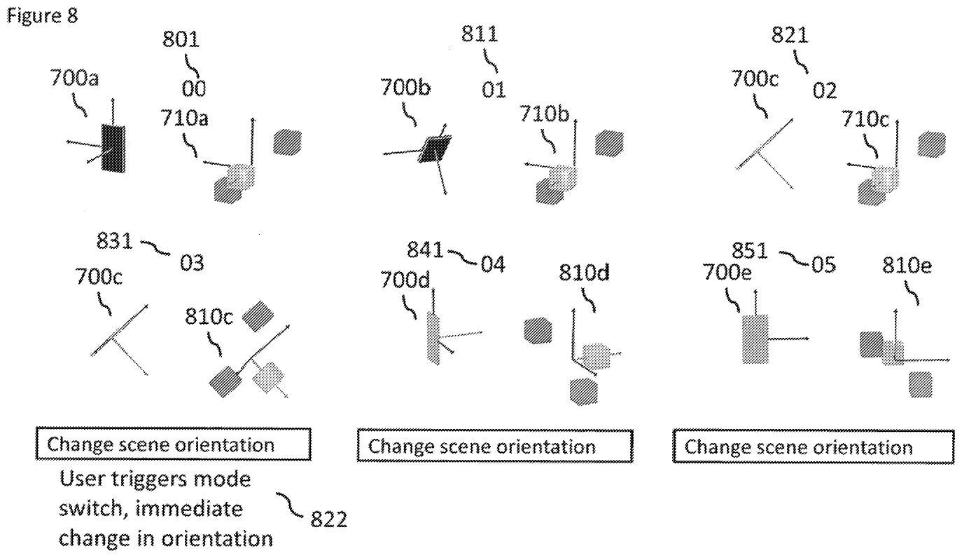

FIG. 8 shows these rotations but in this sequence the capture device or user makes the capture compensation mode switch and where the capture device or user defines a new ‘front’ or reference orientation. It is shown on the left hand side of each element of the sequence an orientation of the capture device shown by the user equipment 700 and on the right hand side of each element a corresponding representation of the audio scene 710/810. In this example the orientation of the capture device changes over time. FIG. 8 for example shows how a capture device in orientation changes between a base or reference state 00 801 where the user device 700a has a base orientation, and a first rotation state 01 811 where the user device 700b has a first rotation orientation and a second rotation state 02 821 where the user device 700c has a second rotation orientation. In this example during these rotations the capture device is configured to perform a rotation compensation. Thus, the default scene orientation 710a is maintained 710b and 710c (in other words the audio scenes 710a, 710b and 710c match) despite the device orientation changing.

At state 03 831 there is no rotation change and the user device 700c has the same orientation as state 02 821 but the front or reference orientation is redefined 822 which causes an immediate change in the scene orientation 810c. Additionally orientation compensation is no more applied, and thus the scene can further change its orientation according to any further device orientation change. Thus, the device in a fourth rotation state 04 841 where the user device 700d has a third rotation orientation and a fifth rotation state 04 841 where the user device 700e. In this example there is thus an abrupt change in the orientation of the audio scene (the default/intended front), which could often be very confusing or annoying. However, when a proper signalling is available, such abrupt change can be smoothed in the rendering.

In both of the above examples, the user (or capture device) switches from a compensated capture to an uncompensated capture.

However in some embodiments the capture device or user could, for example with respect to FIG. 8 maintain a compensated capture where the one abrupt reallocation of the audio scene orientation is carried out. The examples however show that all these options are possible. For example, the user may first operate freely in the captured space and not care about the device orientation. It can thus change, and the device orientation is then compensated in the captured signal domain to maintain a fixed intended scene irrespective of the way the device is rotated at any given time. The user then wishes to bring attention to a feature in the scene and resets the scene front. The capture device or user may then wish to show details to the receiving user or rendering device. In this example it may be necessary/preferable to not compensate for the orientation changes. In fact, these rotations are expressly requested and intended to be presented to the receiver such that a device front for example continues to correspond to scene front. When the receiving user is desired to be able to control the rendering, it thus needs to be signalled both changes.

As such the user and device orientation changes may be continuous in nature. The scene orientation changes may furthermore be continuous or discrete.

Global orientation changes are typically discrete and may in many implementations and implemented services be expected to be set once, for example as part as an initialisation process, and not generally reset or reconfigured while in use. For example, an SDP negotiation or similar information exchange could be used to signal this information from the capture device to the rendering device. In some services/applications, updates (frequent or planned) of the global orientation can be signalled.

Thus to summarise the above in order that the receiving device or renderer (or the user operating the receiving device or renderer) in order to fully control the audio presentation orientation the following information is to be signalled between the capture device to the receiving device:
1. Indication of the intended scene orientation for presentation
2. Indication of whether the scene has orientation compensation applied or not
3. Orientation information of all contributing components

In some embodiments the first piece of information could be implicit within the captured scene. For example, for a scene-based MASA stream or a channel-based 5.1 stream, a default front or reference orientation is a ‘listener’ front or reference orientation. In some embodiments where any other default orientation is desired by a service/application/user, a corresponding rotation can be applied. However where there is a use case for scene-based formats (such as MASA captured on UE with intentional and unintentional device rotations), the default or reference orientation as the ‘front’ orientation is often a dangerous assumption. For example where the capture device is able to reset the front or reference orientation, this will result in an abrupt orientation change that can only be mitigated by smoothing at the capture device. In such examples the quality (and application of such smoothing processing) cannot be guaranteed. Thus, the intended scene orientation for presentation indication is required to be signalled to the receiver.

The second information or indication to be signalled follows from the use case. In examples where it is possible to apply compensation as desired at the capture end, and where it is needed to be able to enable/disable orientation compensation at the receiver, this indication is to be signalled.

The third indication or information can in some cases be the device orientation information only. However in such examples there may be a limit to the uses or services which can implement such a method. In general, all contributing factors need be considered. This can mean at least device orientation and capturing user orientation. For IVAS, it is assumed device orientation is sufficient third indication.

Thus as described in further detail herein the embodiments are configured to obtain (determine or capture) the following information (which may be time-varying) and pass this information to the renderer or playback device. In some embodiments this may be (for example for IVAS) the following:
1. Default scene orientation for presentation
2. Orientation compensation on/off
3. Orientation information of the capturing device

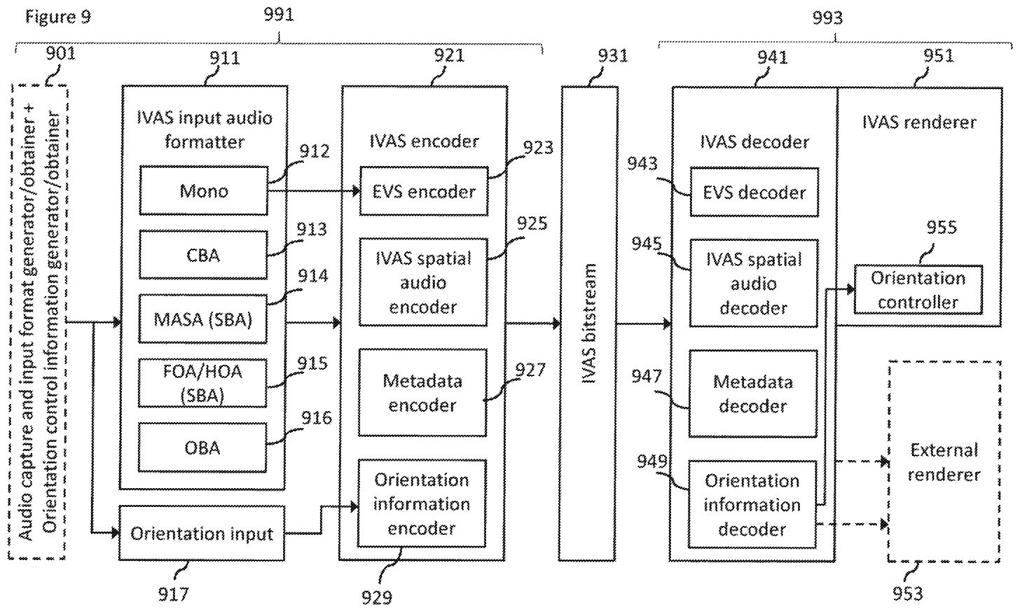

This information (orientation input) can then be provided to an IVAS encoder. With respect to FIG. 9 an example system within which embodiments may be implemented. Furthermore with respect to FIG. 9 is shown an example capture apparatus or device and an example rendering or playback device within the system.

Thus with respect to the capture apparatus 991 there is shown an audio capture and input format generator/obtainer+orientation control information generator/obtainer 901. The audio capture and input format generator/obtainer+orientation control information generator/obtainer 901 is configured to obtain the audio signals and furthermore the orientation control information. The audio signals may be passed to an IVAS input audio formatter 911 and the orientation control information passed to an orientation input 917.

The capture apparatus 991 may furthermore comprise an IVAS input audio formatter 911 which is configured to receive the audio signals from the audio capture and input format generator/obtainer+orientation control information generator/obtainer 901 and format it in a suitable manner to be passed to an IVAS encoder 921. The IVAS input audio formatter 911 may for example comprise a mono formatter 912, configured to generate a suitable mono audio signal. The IVAS input audio formatter 911 may further comprise a CBA (channel based audio signal, for example a 5.1 or 7.1+4 channel audio signals) formatter configured to generate a CBA format and pass it to a suitable audio encoder. The IVAS input audio formatter 911 may further comprise a metadata assisted spatial audio, MASA (SBA—scene based audio signals such as MASA and FOA/HOA), formatter configured to generate a suitable MASA format signal and pass it to a suitable audio encoder. The IVAS input audio formatter 911 may further comprise a first order ambisonics/higher order ambisonics (FOA/HOA) formatter configured to generate a suitable ambisonic format and pass it to a suitable audio encoder. The IVAS input audio formatter 911 may further comprise an object based audio (OBA) formatter configured to generate an object audio format and pass it to a suitable audio encoder.

The capture apparatus 991 may furthermore comprise an orientation input 917 configured to receive the orientation control information and format it/pass it to an orientation information encoder 929 within the IVAS encoder 921.

The capture apparatus 991 may furthermore comprise an IVAS encoder 921. The IVAS encoder 921 can be configured to receive the audio signals and the orientation information and encode it in a suitable manner in order to generate a suitable bitstream, such as an IVAS bitstream 931 to be transmitted or stored.

The IVAS encoder 921 may in some embodiments comprise an EVS encoder 923 configured to receive a mono audio signal, for example from the mono formatter 912 and generate a suitable EVS encoded audio signal.

The IVAS encoder 921 may in some embodiments comprise an IVAS spatial audio encoder 925 configured to receive a suitable format input audio signal and generate suitable IVAS encoded audio signals.

The IVAS encoder 921 may in some embodiments comprise a metadata encoder 927 configured to receive spatial metadata signals, for example from the MASA formatter 914 and generate suitable metadata encoded signals.

The IVAS encoder 921 may in some embodiments comprise orientation information encoder 929 configured to receive the orientation information, for example from the orientation input 917 and generate suitable encoded orientation information signals.

The encoder 921 thus can be configured to transmit the information provided in the orientation input according to its capability to the decoder for rendering with user control. User control is allowed via interface to IVAS renderer or an external renderer.

Thus with respect to the renderer or playback apparatus 993 there is shown an IVAS decoder 941. The IVAS decoder 941 can be configured to receive the encoded audio signals and orientation information and decode it in a suitable manner in order to generate a suitable decoded audio signals and orientation information.

The IVAS decoder 941 may in some embodiments comprise an EVS decoder 943 configured to generate a mono audio signal from the EVS encoded audio signal.

The IVAS decoder 941 may in some embodiments comprise an IVAS spatial audio decoder 945 configured to generate a suitable format audio signal from IVAS encoded audio signals.

The IVAS decoder 941 may in some embodiments comprise a metadata decoder 947 configured to generate spatial metadata signals from metadata encoded signals.

The IVAS decoder 941 may in some embodiments comprise an orientation information decoder 949 configured to generate orientation information from encoded orientation information signals.

In some embodiments the renderer or playback apparatus 993 comprises an IVAS renderer 951 configured to receive the decoded audio signals, decoded metadata and decoded orientation information and generate a suitable rendered output to be output on a suitable output device such as headphones or a loudspeaker system. In some embodiments the IVAS renderer comprises an orientation controller 955 which is configured to receive the orientation information and based on the orientation information (and in some embodiments also user inputs) control the rendering of the audio signals.

In some embodiments the IVAS decoder 941 can be configured to output the orientation information from the orientation information decoder and audio signals to an external renderer 953 which is configured to generate a suitable rendered output to be output on a suitable output device such as headphones or a loudspeaker system based on the orientation information.

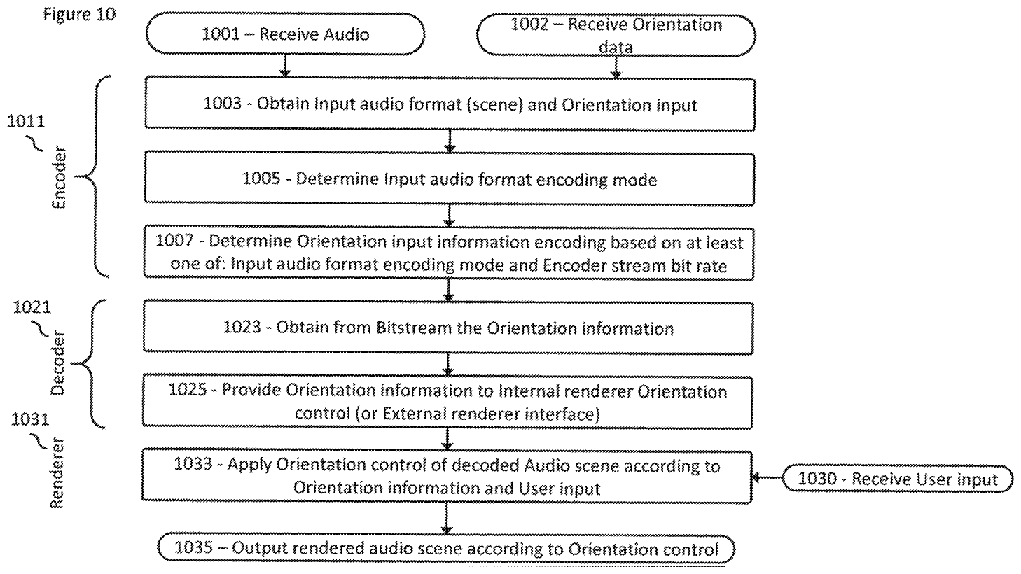

The summary of the operations of the system as shown in FIG. 9 and with respect to the orientation information aspects are shown in FIG. 10.

For example the system may receive audio signals as shown in FIG. 10 by step 1001.

Furthermore it may be received orientation information or orientation data as shown in FIG. 10 by step 1002.

There then follows a series of encoder or capture method operations 1011. These operations may comprise obtaining an input audio format (for example, an audio scene corresponding to any suitable audio format) and orientation input format as shown in FIG. 10 by step 1003.

The next operation may be one of determining an input audio format encoding mode as shown in FIG. 10 by step 1005.

Then there may be an operation of determining an orientation input information encoding based on at least one of an input audio format encoding mode and encoder stream bit rate (i.e., encoding bit rate) as shown in FIG. 10 by step 1007.

The system may furthermore perform decoder operations 1021. The decoder operations may for example comprise obtaining from the bitstream the orientation information as shown in FIG. 10 by step 1023.

Additionally there may be an operation of providing orientation information to an internal renderer orientation control (or to a suitable external renderer interface) as show in FIG. 10 by step 1025.

With respect to the rendering operations 1031 there may be an operation of receiving a user input 1030 and furthermore applying orientation control of decoded audio signals (the audio scene) according to the orientation information and user input as shown in FIG. 10 by step 1033.

The renderer audio scene according to the orientation control can then be output as shown in FIG. 10 by step 1035.

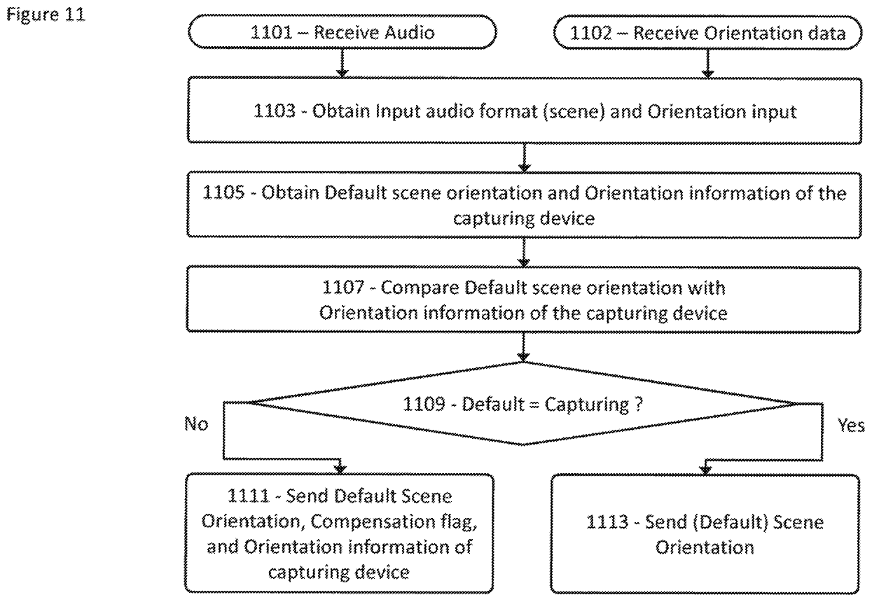

With respect to FIG. 11 is shown a flow diagram of the operations of the encoder with respect to the orientation information aspects of some embodiments.

For example the flow diagram of FIG. 11 shows a first set of operations of receiving audio signals as shown in FIG. 11 by step 1101 and receiving orientation information or orientation data as shown in FIG. 11 by step 1102. In other words passing input audio (scene) according to a suitable audio format and orientation data according to the audio (scene) to an audio encoder.

The next operation is one of obtaining an input audio format (the audio scene) and an orientation information in a suitable format for encoding as shown in FIG. 11 by step 1103.

Additionally it may be obtained/determined based on the inputs, a default audio scene orientation and any orientation information of the capture device (including any orientation compensation flag) as shown in FIG. 11 by step 1105.

The operations may furthermore comprise comparing the default scene orientation with the orientation information of the capturing device as shown in FIG. 11 by step 1107.

In some embodiments furthermore the comparison is used in a check operation as shown in FIG. 11 by step 1109 to determine whether the default scene orientation is that of the capturing apparatus.

Where the orientations match then the next operation may be one of transmitting/storing the (default) scene orientation to allow rendering as shown in FIG. 11 by step 1113. In some embodiments, the check may be according to a quantizer step or some other suitable threshold that may depend on encoding bit rate.

Where the orientations do not match then the next operation may be one of transmitting the information allowing orientation control (which may for example be orientation compensation information to correct for any device rotation or to undo a correction and follow device orientation instead of default scene orientation) as shown in FIG. 11 by step 1111.

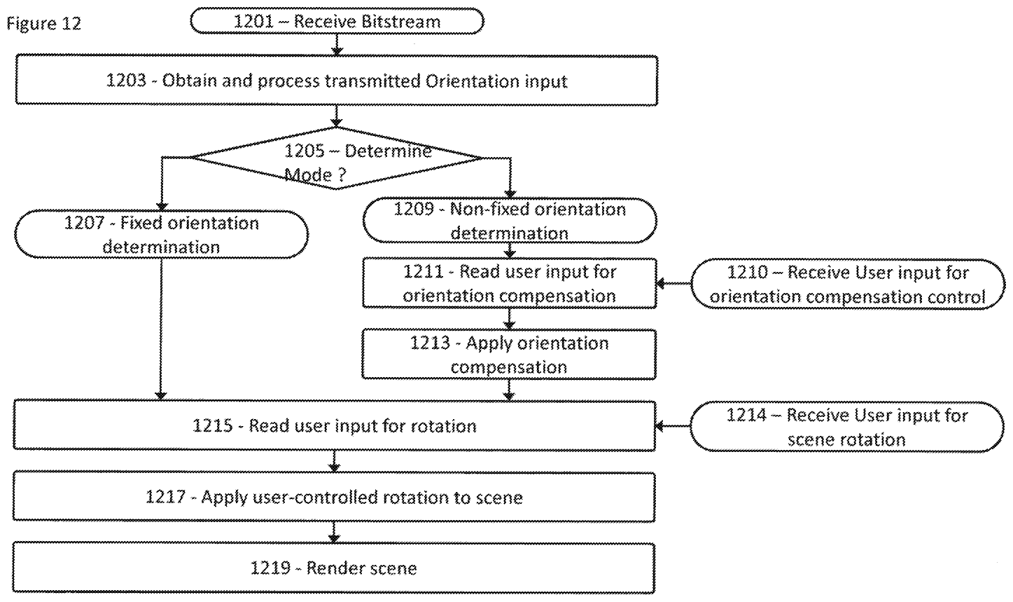

With respect to FIG. 12 is shown in further detail a flow diagram of the operations of the decoder with respect to the orientation information aspects of some embodiments.

Thus for example in some embodiments the bitstream is received as shown in FIG. 12 by step 1201.

Following the obtaining or receiving of the bitstream the next operation may be obtaining for processing the transmitted/quantized orientation information as shown in FIG. 12 by step 1203.

Next may be an operation of selecting or determining a mode for orientation compensation based on the orientation information as shown in FIG. 12 by step 1205.

Where the determination indicates that there is (default) scene orientation only then the mode is a fixed orientation mode as shown in FIG. 12 by step 1207.

Where the determination indicates that there is other orientation information then the method may determine the renderer/decoder is able to select a non-fixed orientation mode as shown in FIG. 12 by step 1209.

Additionally there may be received user input for orientation compensation control as shown in FIG. 12 by step 1210.

Based on the orientation compensation control user input and the determination on the non-fixed orientation mode then the user input may be read as shown in FIG. 12 by step 1211.

Having read the user input the next operation may be based on applying orientation compensation when indicated to apply it according to some embodiments as shown in FIG. 12 by step 1213.

Additionally in some embodiments there may be received user input for scene rotation as shown in FIG. 12 by step 1214 (this may be independent of the capturing device rotation compensation). For example, a receiving user may wish to rotate an audio scene in certain way, e.g., in order to place an interesting audio source in front of them.

In some embodiments the user input for scene rotation can then be read as shown in FIG. 12 by step 1215. In some embodiments where the renderer/application allows for no user input for scene rotation, a fixed orientation mode indication is passed to the renderer and the rendering of the audio scene performed in such a manner (in other words a scene rotation operation as shown below bypassed).

In a non-fixed orientation mode having read the user input for orientation compensation then based on the transmitted data and user input any relevant orientation compensation is applied to the scene as shown in FIG. 12 by step 1217.

The rendering of the audio scene according to the final orientation is then performed as shown in FIG. 12 by step 1219.

In some implementations, the user-controlled orientation compensation control and user-controlled scene rotation functionalities may be combined. In some embodiments an application UI is configured to handle the inputting of both of the orientation compensation control and the scene rotation together, since they both relate to some scene rotation information and functionality. However, they are different functionalities.

In some embodiments the orientation information can be defined as a time-varying signal which is associated with or extends over the IVAS signalling presented above. In some embodiments the time-varying signal may comprise the following parameters or items:
1. Global orientation
2. Default scene orientation for presentation
3. Orientation compensation description and on/off flag
4. Orientation information of the capturing device
5. Orientation information of the capturing user

In some embodiments this information is provided to the (IVAS) encoder. However in some embodiments the global orientation (updates) and orientation of the capturing user are not included or not updated (or at least one not updated regularly). Furthermore in some embodiments this information can be transmitted only when the bitstream capacity is above a suitable threshold (in other words the application is operating at relatively high bit rates).

In some embodiments the encoder may be other encoders or used in other situations. For example the orientation information may be obtained and encoded as part of a MPEG-I 6DoF Audio stream, where the user-generated scene is mapped relative to a main MPEG content scene. Thus, global orientation information may be used and thus included. Also, it can be considered that the user orientation at least in terms of virtual user location is to be obtained and to be transmitted and rendered. Thus, all of the time-varying parameters may be included in MPEG-I 6DoF Audio applications.

It is also noted that in some use cases there could potentially be more than one capturing user and/or more than one capture device. In some embodiments therefore there is a synchronization of the orientation of more than one scene. Although the above examples relate to a single scene, in some embodiments a global orientation information/indication signalling can be implemented and used.

As described above, in some embodiments the (IVAS) encoder is configured to generate information or signal to the receiver/renderer/decoder
1) the audio scene (default) presentation orientation,
2) a flag describing whether orientation compensation has been applied or not, and
3) orientation information of the capturing device.

In some embodiments for practical low-bit rate operation an efficient representation of this information is generated and used.

An example of a signaling implementation according to some embodiments may be (for example in case of MASA) as follows. In the example below the quantization of the metadata is performed using a spherical indexing framework.

A proposed orientation representation can be two components:
1) direction and
2) rotation around said direction.

This information is described for example in terms of two points on a spherical grid (where ‘no rotation’ can be represented using a repetition of the first direction point or an escape code). As each orientation can thusly be represented using two points on a spherical grid, four points can be used to represent two orientations: audio scene (default/intended/preferred) presentation orientation and (capture) device orientation.

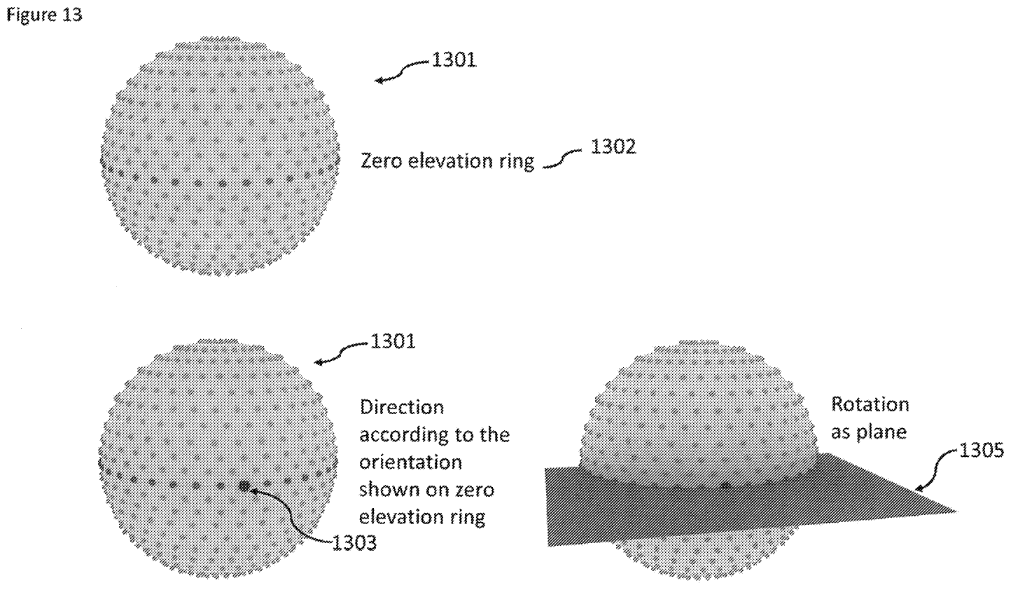

With respect to FIG. 13 is shown a first component within the example orientation representation using the spherical indexing 1301 of the quantization locations. In this example there can be assumed (for illustrative purposes) that there is a reference orientation which corresponds to a main direction that is expressed as azimuth value α for a 0-elevation. Thus, the selected direction index is the closest spherical index point on the 0-elevation ring 1302 corresponding to the input direction.

This is for example shown in FIG. 13 by the bottom left image where the direction according to the orientation shown in the zero elevation ring is marked as reference 1303.

This direction 1303 can be used to define a plane 1305 that is used to indicate the rotation around the direction.

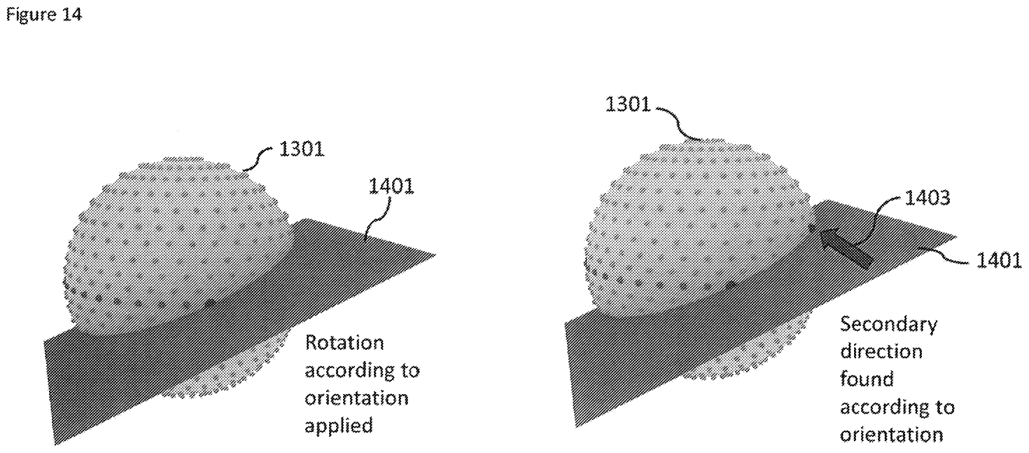

With respect to FIG. 14 is illustrates the second component within the example orientation representation. A rotation is applied to the spherical representation 1301 to the plane shown in FIG. 13 such that the rotated plane 1401 is based on the (scene) orientation. As the direction provides the azimuth and elevation for the orientation, further roll information is required to understand the rotation. The roll information may be determined from the spherical index grid as a point 1403 that lies on the plane (or is closest to it). This point 1403 can be used to represent the rotation. In some embodiments the second point may define two rotations (180-degree difference) and therefore can indicate which of the two candidate rotations is the correct rotation. This indication can be based, for example, on the side relative to the direction point the selected point lies on.

An example definition may be the following:
It is considered the second point direction on the sphere relative to the direction given by the first point;
If the second point is on left-hand side or upwards of the first direction, the rotation is this direction;
If the second point is on right-hand side or downwards of the first direction, the rotation is +180 degrees.

In such embodiments a single orientation can be defined by two points on the sphere. The proposed signalling allows for efficient encoding and updates of the intended scene orientation and the orientation compensation information of the capturing device using the functions of the spherical indexing system. This allows for determining, e.g., based on the total bit rate a suitable accuracy and bit consumption for the orientation information. For example, default orientation and orientation compensation information can be encoded based on a difference from the former to the latter. The update rate may also depend on the bit rate.

As described in some embodiments may utilize a spherical grid model.

The spatial direction can in such embodiments be expressed, e.g., based on elevation and the azimuth. Each pair of values containing the elevation and the azimuth is first quantized on a spatial spherical grid of points and the index of the corresponding point is constructed. The spherical grid as proposed herein is based on a sphere of unitary radius that is defined by the following elements:
Uniform scalar quantizer for the elevation values between −90 and +90 degrees; the value 0 is contained in the codebook. The distance between consecutive elevation codewords is 0.7388 degrees. The values are symmetrical with respect to the origin. The number of positive elevation codewords is N_{θ}.
For each elevation codeword value there are several equally spaced azimuth values defined such that the distance between the consecutive resulting points on the unitary sphere is the same irrespective of the elevation codeword value. One point is given by the elevation and the azimuth value. The number n(i) of azimuth values are calculated as follows:

$$n ( 1 ) = 422$$

$$n ( i ) = \frac{π}{{sin}^{- 1} \frac{sin \frac{π}{n ( 1 )}}{R ( i )}} , i = 1 : {N}_{θ}$$

$$R ( i ) = cos ( ( i - 1 ) ϕ ) , i = 1 : {N}_{θ}$$

$$ϕ = {sin}^{- 1} \frac{2 \sqrt{3} sin \frac{π}{n ( 1 )}}{6 \sqrt{1 - {( sin \frac{π}{n ( 1 )} )}^{2}}} + {sin}^{- 1} ( \frac{2 \sqrt{3}}{3} sin \frac{π}{n ( 1 )} )$$

The azimuth values for even values of i are equally spaced and start at 0.
The azimuth values for odd value of i are equally spacea ana start at

$$\frac{π}{n ( i )} .$$

There is a same number of azimuth values for same absolute value elevation codewords.

The quantization in the spherical grid is done as follows:
The elevation value is quantized in the uniform scalar quantizer to the two closest values θ₁, θ₂
The azimuth value is quantized in the azimuth scalar quantizers corresponding to the elevation values θ₁, θ₂
The distance on the sphere is calculated between the input elevation azimuth pair and each of the quantized pairs (θ₁, ϕ₁), (θ₂, ϕ₂)

dᵢ=−(sin θ sin θᵢ+cos θᵢ cos(ϕ−ϕᵢ)),i=1:2
The pair with lower distance is chosen as quantized direction.

The resulting quantized direction index is obtained by enumerating the points on the spherical grid by starting with the points for null elevation first, then the points corresponding to the smallest positive elevation codeword, the points corresponding to the first negative elevation codeword, followed by the points on the following positive elevation codeword and so on.

It is understood that in some embodiments resolutions other than those discussed above can be used.

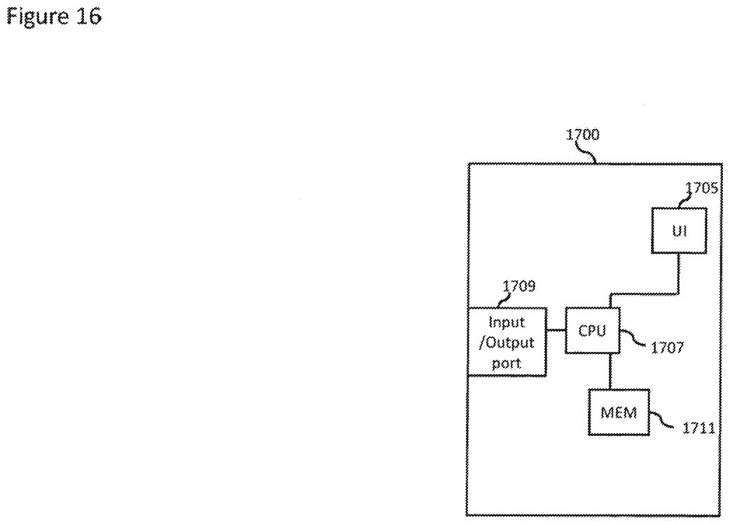

With respect to FIG. 16 an example electronic device which may be used as any of the apparatus parts of the system as described above. The device may be any suitable electronics device or apparatus. For example in some embodiments the device 1700 is a mobile device, user equipment, tablet computer, computer, audio playback apparatus, etc.

In some embodiments the device 1700 comprises at least one processor or central processing unit 1707 The processor 1707 can be configured to execute various program codes such as the methods such as described herein.

In some embodiments the device 1700 comprises a memory 1711. In some embodiments the at least one processor 1707 is coupled to the memory 1711. The memory 1711 can be any suitable storage means. In some embodiments the memory 1711 comprises a program code section for storing program codes implementable upon the processor 1707. Furthermore in some embodiments the memory 1711 can further comprise a stored data section for storing data, for example data that has been processed or to be processed in accordance with the embodiments as described herein. The implemented program code stored within the program code section and the data stored within the stored data section can be retrieved by the processor 1707 whenever needed via the memory-processor coupling.

In some embodiments the device 1700 comprises a user interface 1705. The user interface 1705 can be coupled in some embodiments to the processor 1707. In some embodiments the processor 1707 can control the operation of the user interface 1705 and receive inputs from the user interface 1705. In some embodiments the user interface 1705 can enable a user to input commands to the device 1700, for example via a keypad. In some embodiments the user interface 1705 can enable the user to obtain information from the device 1700. For example the user interface 1705 may comprise a display configured to display information from the device 1700 to the user. The user interface 1705 can in some embodiments comprise a touch screen or touch interface capable of both enabling information to be entered to the device 1700 and further displaying information to the user of the device 1700. In some embodiments the user interface 1705 may be the user interface for communicating.

In some embodiments the device 1700 comprises an input/output port 1709. The input/output port 1709 in some embodiments comprises a transceiver. The transceiver in such embodiments can be coupled to the processor 1707 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1709 may be configured to receive the signals.

In some embodiments the device 1700 may be employed as at least part of the synthesis device. The input/output port 1709 may be coupled to any suitable audio output for example to a multichannel speaker system and/or headphones (which may be a headtracked or a non-tracked headphones) or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising:
at least one processor; and
at least one non-transitory memory including a computer program code,
the at least one memory and the computer program code configured to, with the at least one processor, cause the apparatus at least to:
obtain at least one spatial audio scene comprising at least one audio signal;
obtain orientation information associated with the apparatus, wherein the orientation information comprises information associated with a default scene orientation; orientation of the apparatus; and orientation compensation;
encode the at least one spatial audio scene comprising the at least one audio signal;
encode the orientation information; and
output or store the encoded at least one spatial audio scene and the encoded orientation information.

2. The apparatus as claimed in claim 1, wherein the orientation information further comprises at least one of:
orientation of a user operating the apparatus;
information indicating whether the orientation compensation is being applied to the at least one audio signal with the apparatus;
description for the orientation compensation;
an orientation reference; or
orientation information identifying a global orientation reference.

3. The apparatus as claimed in claim 1, wherein the at least one memory and the computer program code are configured to, with the at least one processor, cause the apparatus to obtain the orientation information for at least one of:
at least in part of an initialization procedure;
on a regular basis determined with a time period;
based on a user input requesting the orientation information; or
based on a determined operation mode change of the apparatus.

4. The apparatus as claimed in claim 1, wherein the at least one memory and the computer program code are configured to, with the at least one processor, at least one of:
encode the orientation information based on a determination of a format of the encoded at least one audio signal; or
encode the orientation information based on a determination of an available bit rate for the encoded orientation information.

5. The apparatus as claimed in claim 1, wherein the at least one memory and the computer program code are configured to, with the at least one processor, cause the apparatus to:
compare the information associated with the default scene orientation and orientation of the apparatus;
encode the information associated with the default scene orientation and the orientation of the apparatus based on the comparison when differing by more than a threshold value; and
encode the information associated with the default scene orientation based on the comparison when differing by less than the threshold value.

6. The apparatus as claimed in claim 5, wherein the threshold value is based on a quantization distance used to encode the orientation information.

7. The apparatus as claimed in claim 1, wherein the at least one memory and the computer program code are configured to, with the at least one processor, to cause the apparatus to:
determine a plurality of indexed elevation values and indexed azimuth values as points on a grid arranged in a form of a sphere, wherein the spherical grid is formed with covering the sphere with smaller spheres, wherein the smaller spheres define the points of the spherical grid;
identify a reference orientation within the grid as a zero elevation ring;
identify a point on the grid closest to a first selected direction index;
apply a rotation based on the orientation information to a plane;
identify a second point on the grid closest to the rotated plane; and
encode the orientation information based on the point on the grid and the second point on the grid.

8. The apparatus as claimed in claim 1, wherein the at least one memory and the computer program code are configured to, with the at least one processor, cause the apparatus to capture the at least one spatial audio scene comprising the at least one audio signal.

9. An apparatus comprising:
at least one processor; and
at least one non-transitory memory including a computer program code,
the at least one memory and the computer program code configured to, with the at least one processor, cause the apparatus at least to:
obtain an encoded at least one audio signal and an encoded orientation information, wherein the at least one audio signal is part of a spatial audio scene obtained with a further apparatus and the encoded orientation information is associated with the further apparatus;
decode the encoded at least one audio signal;
decode the encoded orientation information, wherein the orientation information comprises information associated with a default scene orientation, orientation of the further apparatus and orientation compensation; and
provide the decoded orientation information to signal process the at least one audio signal based on the orientation compensation, the default scene orientation and the orientation of the further apparatus.

10. The apparatus as claimed in claim 9, wherein the orientation information further comprises at least one of:
orientation of a user operating the further apparatus;
information indicating whether the orientation compensation is being applied to the at least one audio signal with the further apparatus;
an orientation reference; or
orientation information identifying a global orientation reference.

11. The apparatus as claimed in claim 9, wherein the at least one memory and the computer program code are configured to, with the at least one processor, cause the apparatus to obtain the encoded orientation information for at least one of:
at least in part of an initialization procedure;
on a regular basis determined with a time period;
based on a user input requesting the orientation information; or
based on a determined operation mode change of the further apparatus.

12. The apparatus as claimed in claim 9, wherein the at least one memory and the computer program code are configured to, with the at least one processor, cause the apparatus to at least one of:
decode the encoded orientation information based on a determination of a format of the encoded at least one audio signal; or
decode the encoded orientation information based on a determination of an available bit rate for the encoded orientation information.

13. The apparatus as claimed in claim 9, wherein the at least one memory and the computer program code are configured to, with the at least one processor, cause the apparatus to:
determine whether there is separately encoded information associated with the default scene orientation and the orientation of the further apparatus;
decode the orientation information associated with the default scene orientation and the orientation of the further apparatus based on the separately encoded information associated with the default scene orientation and the orientation of the further apparatus; and
determine the orientation of the further apparatus as the encoded information associated with the default scene orientation when there is the encoded information associated with the default scene orientation is present.

14. The apparatus as claimed in claim 9, wherein the at least one memory and the computer program code are configured to, with the at least one processor, cause the apparatus to:
determine within the orientation information a first index representing a point on a grid of indexed elevation values and indexed azimuth values, and a second index representing a second point on the grid of indexed elevation values and indexed azimuth values, wherein the grid is arranged in a form of a sphere, wherein the spherical grid is formed with covering the sphere with smaller spheres, wherein the smaller spheres define the points of the spherical grid;
identify a reference orientation within the grid as a zero elevation ring;
identify a point on the grid closest to the first index on the zero elevation ring;
identify a rotation by a plane on the zero elevation ring through the point on the grid closest to the first index which results in a rotating plane also passing through the second point on the grid; and
wherein the orientation information is the rotation.

15. The apparatus as claimed in claim 14, wherein the at least one memory and the computer program code are configured to, with the at least one processor, cause the apparatus to identify a rotation by a plane on the zero elevation ring through the point on the grid closest to the first index which results in a rotating plane also passing through the second point on the grid to:
determine whether the second point is on the right-hand side or downwards of the first plane; and
apply an additional rotation 180 degrees when the second point is on the right-hand side or downwards of the first plane.

16. The apparatus as claimed in claim 9, wherein the at least one memory and the computer program code are configured to, with the at least one processor, cause the apparatus to signal process the at least one audio signal based on the default scene orientation and the orientation of the further apparatus.

17. The apparatus as claimed in claim 16, wherein the at least one memory and the computer program code are configured to, with the at least one processor, cause the apparatus to:
determine at least one orientation control user input or orientation control indicator; and
apply an orientation compensation processing to the at least one audio signal based on the default scene orientation, orientation of the further apparatus and the at least one orientation control user input or orientation control indicator.

18. The apparatus as claimed in claim 17, wherein the at least one memory and the computer program code are configured to, with the at least one processor, cause the apparatus to:
determine at least one audio scene rotation control user input; and
apply a scene rotation processing to the at least one audio signal based on:
the default scene orientation,
the orientation of the further apparatus, and
the at least one audio scene rotation user input.

19. A method comprising:
obtaining at least one spatial audio scene comprising at least one audio signal;
obtaining orientation information associated with an apparatus, wherein the orientation information comprises information associated with a default scene orientation, orientation of the apparatus and orientation compensation;
encoding the at least one audio signal;
encoding the orientation information; and
outputting or storing the encoded at least one audio signal and the encoded orientation information.

20. A method comprising:
obtaining at an apparatus an encoded at least one audio signal and encoded orientation information, wherein the at least one audio signal is part of an audio scene obtained with a further apparatus and the encoded orientation is associated with the further apparatus;
decoding the at least one audio signal;
decoding the encoded orientation information, wherein the orientation information comprises information associated with a default scene orientation, orientation of the further apparatus and orientation compensation; and
providing the decoded orientation information to signal process the at least one audio signal based on the default scene orientation, the orientation of the further apparatus and the orientation compensation.

21-22. (canceled)
